(19) United States
(12) Patent Application Publication
(10) Pub. No.: US 2007/0179784 A1
(43) Pub. Date: Aug. 2, 2007

(54) Dynamic match lattice spotting for indexing speech content

(75) Inventors: Albert Joseph Kishan Thambiratnam, Queensland (AU); Subramanian Sridharan, Queensland (AU)

Correspondence Address: MYERS BIGEL SIBLEY & SAJOVEC, PO BOX 37428, RALEIGH, NC, 27627, US

(73) Assignee: Queensland University of Technology

(21) Appl. No.: 11/377,327

(22) Filed: Mar. 16, 2006

(30) Foreign Application Priority Data
Feb. 2, 2006 (AU) 2006900497

(51) Int. Cl. G10L 15/28

(52) U.S. Cl. 704/255

(57) ABSTRACT

A system for indexing and searching speech content, the system includes two distinct stages, a speech indexing stage (100) and a speech retrieval stage (200). A phone lattice (103) is generated by passing speech content (101) through a speech recogniser (102). The resulting phone lattice is then processed to produce a set of observed sequences Q=(Θ,i) where Θ are the set of observed phone sequences for each node i in the phone lattice. During the retrieval stage (200), a user first inputs a target word (205) into the system, which is then reduced to a target phone sequence P=(p₁, p₂, . . . , p_{N}) (207). The system then compares target sequence P with the set of observed sequences Q (208), suitably by scoring each observed sequence against the target sequence using a Minimum Edit Distance (MED) calculation to produce a set of matching sequences R (209).

### RELATED APPLICATION

The application claims the benefit of priority to Australian Patent Application Serial No. 2006900497, filed Feb. 2, 2006, the contents of which are hereby incorporated by reference as if recited in full herein.

### BACKGROUND TO THE INVENTION

1. Field of the Invention

The present invention generally relates to speech indexing. In particular, although not exclusively, the present invention relates to an improved unrestricted vocabulary speech indexing system and method for audio, video and multimedia data.

2. Discussion of Background Art

The continued development of a number of transmission and storage media such as the Internet has seen an increase in the transmission of various forms of information such as voice, video and multimedia data. The rapid growth in such transmission media has necessitated the development of a number technologies that can index and search the multitude of available data formats effectively (e.g. Internet search engines). Such systems are and will continue to be paramount in providing an effective means of accessing information provided within these data formats.

One method of indexing and searching large speech corpora has been to use a two-pass speech transcription approach. Speech is first prepared for indexing by using a large vocabulary speech recogniser to generate approximate textual transcriptions. These transcriptions are then indexed using traditional text indexing approaches, thus allowing rapid information retrieval at search time.

Unfortunately, such an approach is severely restricted by the vocabulary of the speech recogniser used to generate textual transcriptions. The vocabulary of a speech recogniser is usually a finite size, and thus it is unlikely to contain every word that may be of interest in speech search, such as names, acronyms and foreign keywords. Since the content of any generated transcripts are constrained by the vocabulary of the speech recogniser, the set of possible query words is thus finite.

A constrained query vocabulary poses significant implications for many types of speech search applications with dynamic or very large vocabularies. These include tasks such as news-story indexing, technical document database searching and multi-language surveillance. As such, novel techniques are required that allow unrestricted vocabulary speech indexing and retrieval.

Another approach is to use acoustic keyword spotting techniques, such as the method described by J. R. Rohlicek in Modern Methods of Speech Processing. Here, audio content is searched at query time using a simplified recogniser that has been dynamically tuned for the detection of the query words only. Such a search is considerably faster than performing a complete transcription of the speech. However, the technique is not scalable to searching very large corpora, as the required acoustic processing is still considerably slower than typical text-based search techniques.

A considerably faster unrestricted vocabulary search approach using a reverse dictionary lookup was proposed by S. Dharanipragada and S. Roukos, “A multistage algorithm for spotting new words in speech,” IEEE Transactions on, Speech and Audio Processing, vol. 10, no. 8, pp. 542-550, November 2002. In this approach, the speech is first processed offline to generate low-level phonetic or syllabic transcriptions. At query time, the target words are first decomposed into their low-level phonetic/syllabic representations, and then the intermediary transcriptions are searched in a bottom-up fashion to infer the locations of the query words. Unfortunately, the phonetic/syllabic transcriptions upon which this approach is based are typically quite erroneous, since accurate phonetic/syllabic transcription in itself is a difficult task. As a result, the overall approach suffers from poor detection error rates.

Phone lattice based searching is another fast unrestricted vocabulary search technique, proposed by S. J. Young and M. G. Brown, “Acoustic indexing for multimedia retrieval and browsing” in IEEE International Conference on Acoustics, Speech, and Signal Processing, vol. 1, pp. 199-202 April 1997. This technique attempts to incorporate a degree of robustness to phone recogniser error by indexing the speech using phonetic lattices rather than transcriptions.

Phone lattices encode a significantly greater number of recognition paths than phone transcriptions, and therefore preserve a considerably broader search space for query time processing. As a result, the phone lattice approach tends to achieve better detection error rates than the above discussed approaches. However, the resulting error rates are still quite poor and have thus presented a significant barrier for usable information retrieval.

Thus a system and method for indexing and retrieval of various data formats such as speech is required that allows accurate yet rapid search of large information repositories.

### DISCLOSURE OF THE INVENTION

### Object of the Invention

Clearly it would be advantageous to provide system and method that provides significantly more user-friendly access to the important information contained in the vast amounts of speech and multimedia being generated daily.

### SUMMARY OF THE INVENTION

Accordingly in one aspect of the present invention there is provided a method of indexing speech content, the method comprising the steps of:
generating a phone lattice from said speech content;
processing the phone lattice to generate a set of observed sequences Q=(Θ,i), wherein Θ are the observed sequences for each node i in said phone lattice; and
storing said set of observed sequences Q=(Θ,i) for each node.

In a further aspect of the present invention there is provided a method for searching indexed speech content wherein said indexed speech content is stored in the form of a phone lattice, the method comprising the steps of:
obtaining a target sequence P=(p₁, p₂, p₃, . . . , p_{N});
comparing the target sequence P with a set of observed sequences Q=(Θ,i) generated for each node i in said phone lattice wherein the comparison between the target sequence and observed sequences includes scoring each observed sequence against the target sequence using a Minimum Edit Distance calculation; and
outputting a set of sequences R from said set of observed sequences Q=(Θ,i) that match said target sequence.

In yet another aspect of the present invention there is provided a method of indexing and searching speech content, the method comprising the steps of:
generating a phone lattice from said speech content;
processing the phone lattice to generate a set of observed sequences Q=(Θ,i), wherein Θ are the observed sequences for each node i in said phone lattice;
storing said set of observed sequences Q=(Θ,i) for each node;
obtaining a target sequence P=(p₁, p₂, p₃, . . , p_{N});
comparing said target sequence P with the set of observed sequences Q=(Θ,i) wherein the comparison between the target sequence and observed sequences includes scoring each observed sequence against the target sequence using a Minimum Edit Distance calculation; and
outputting a set of sequences R from said set of observed sequences Q=(Θ,i) that match said target sequence.

Preferably the step of generating the phone lattice further comprises optimising the size and complexity of said lattice by selecting from the following sub-steps: tuning the number of tokens U used to produce the lattice; lattice pruning to remove less likely paths outside the pruning beamwidth W; and/or tuning the number of lattice traversals V.

In a still further aspect of the present invention there is provided a system for indexing speech content, the system comprising:
a speech recognition engine for generating a phone lattice from speech content;
a first database for storing said phone lattice generated by said recognition engine; and
at least one processor coupled to database storage and configured to:
   process said phone lattice to generate a set of observed sequences Q=(Θ,i), wherein Θ are the observed sequences for each node i in said phone lattice; and
   store said observed sequences Q=(Θ,i) in a second database.

In another aspect of the present invention there is provided a system for searching indexed speech content wherein said indexed speech content is stored in the form of an observed phone sequence database, the system including:
an input device for obtaining a target sequence P=(p₁, pp₂, p₃, . . . , p_{N});
a database containing a set of observed sequences Q=(Θ,i) generated for each node i in said phone lattice; and
at least one processor coupled to database storage and configured to:
   compare said target sequence P with the set of observed sequences Q=(Θ,i) wherein the comparison between the target sequence and observed sequences includes scoring each observed sequence against the target sequence using a Minimum Edit Distance calculation; and
   output a set of sequences from said set of observed sequences Q=(Θ,i) that match said target sequence.

In yet another aspect of the present invention there is provided a system for indexing and searching speech content, the system including:
a speech recognition engine for generating a phone lattice from speech content;
a first database for storing said phone lattice generated by said recognition engine;
an input device for obtaining a target sequence P=(p₁, p₂, p₃, . . . , p_{N}); and
at least one processor coupled to said input device and database storage, which processor is configured to:
   process said phone lattice to generate a set of observed sequences Q=(Θ,i) wherein Θ are the observed sequences for each node i in said phone lattice;
   store said observed sequences Q=(Θ,i) in a second database;
   compare said target sequence P with the set of observed sequences Q=(Θ,i) wherein the comparison between the target sequence and observed sequences includes scoring each observed sequence against the target sequence using a Minimum Edit Distance calculation; and
   output a set of sequences R from said set of observed sequences Q=(Θ,i) that match said target sequence.

The speech content may be in the form of a plurality of speech files, audio files, video files or other suitable multimedia data type.

Preferably the speech recognition engine is configured to perform a feature based extraction process to generate a feature-based representation of the speech files to construct a phone recognition network and to perform an N-best decoding utilising said phone recognition network to produce the phone lattice.

The feature based extraction process may be performed by suitable speech recognition software. Suitably the phone recognition network is constructed using a number of available techniques such as phone loop or phone sequence fragment loop wherein common M-Length phone grams are placed in parallel. Preferably the N-best decoding utilises a well-trained set of acoustic models such as tri-phone Hidden Markov Models (HMM), and an appropriate language model such as an N-gram language model in conjunction with the phone recognition network to produce the phone lattice. Preferably the size and complexity the lattice is optimised utilising one or more of the following; tuning the number of tokens U used to produce the lattice, lattice pruning to remove less likely paths outside the pruning beamwidth W, and/or tuning the number of lattice traversals V tokens.

The set of observed sequences Q=(Θ,i) may be in the form of a constrained sequence set Q′=(Θ,i,K); i.e. the constrained sequence set Q′=(Θ,i) containing the K top scoring sequences wherein Q′=(Θ,i,K) is derived by the equation Q′(Θ,i,K)={Γ^{k} ∈Γ(Q)|H(Γ^{k})≧H(Γ^{K})}.

Suitably the Minimum Edit Distance scoring comprises calculating the minimum cost Δ(A,B) of transforming the observed sequence to the target sequence in accordance with a set of insertion Cᵢ⁻¹, deletion C_{d}⁻¹, substitution Cₛ and match operations wherein Δ(A,B) is defined by Δ(A,B)=BESTMED(A, B, Cᵢ⁻¹, C_{d}⁻¹, Cₛ) and where BESTMED( . . . ) returns the last column of the MED cost matrix that is less than the maximum MED score threshold Sₘₐₓ. Preferably the MED cost matrix is produced in accordance with a Levenstein algorithm.

The generation of the cost function Cᵢ⁻¹ may utilise one or more cost rules including same letter substitution, vowel substitution and/or closure/stop substitution. Suitably the maximum MED score threshold Sₘₐₓ is adjusted to the optimal value for a given lattice (i.e. the value of Sₘₐₓ is adjusted so as to reduce the number of false alarms per keyword searched without substantive loss query-time execution speeds for a given lattice).

Suitably the process of calculating the Minimum Edit Distance cost matrix further comprises the steps of applying prefix sequence optimisation and/or early stopping optimisation, and/or a linearizing the cost matrix.

In a further aspect of the present invention the set of observed sequences Q=(Θ,i) may undergo further processing to produce a set of hypersequences. Each hypersequence may then be used to represent a particular group of observed sequences Q=(Θ,i). Preferably the hypersequences are generated by mapping the observed sequences to a hypersequence domain in accordance with a suitable mapping function.

Suitably the mapping of the observed sequences to domain is performed on an element by element basis using a mapping method selected from a linguistic knowledge based mapping, a data driven acoustic mapping, and a context dependent mapping.

Preferably the comparison of the target sequence and the observed sequences comprises:
comparing the target sequence with each hypersequence to identify the sequence groups most likely to yield a match for the target sequence; and
comparing said target sequence with the set of observed sequences Q=(Θ,i) contained within the identified hypersequence sequence group/s.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is schematic diagram of a speech indexing system in accordance with an embodiment of the present invention;

FIGS. 2A, 2B and 2C are schematic diagrams depicting the sequence generation process according to an embodiment of the present invention;

FIG. 3 is a schematic diagram depicting the speech retrieval process according to an embodiment of the invention;

FIG. 4 is a schematic depicting the hypersequence generation process according to an embodiment of the present invention

FIG. 5 is a schematic diagram depicting the speech retrieval process according to an embodiment of the invention;

FIG. 6 is an example of a cost matrix for transforming the word deranged to hanged calculated using a Levenstein algorithm in accordance with an embodiment of the invention;

FIG. 7 is a schematic diagram illustrating the effects of manipulating the lattice traversal token parameter in accordance with an embodiment of the invention;

FIG. 8 is an example of the relationship between cost matrices for sub-sequences utilised in the prefix optimisation process according to an embodiment of the present invention; and

FIG. 9 is an example of the Minimum Edit Distance prefix optimisation algorithm applied in an embodiment of the present invention.

### DETAILED DESCRIPTION OF THE PREFERRED EMBODIMENTS

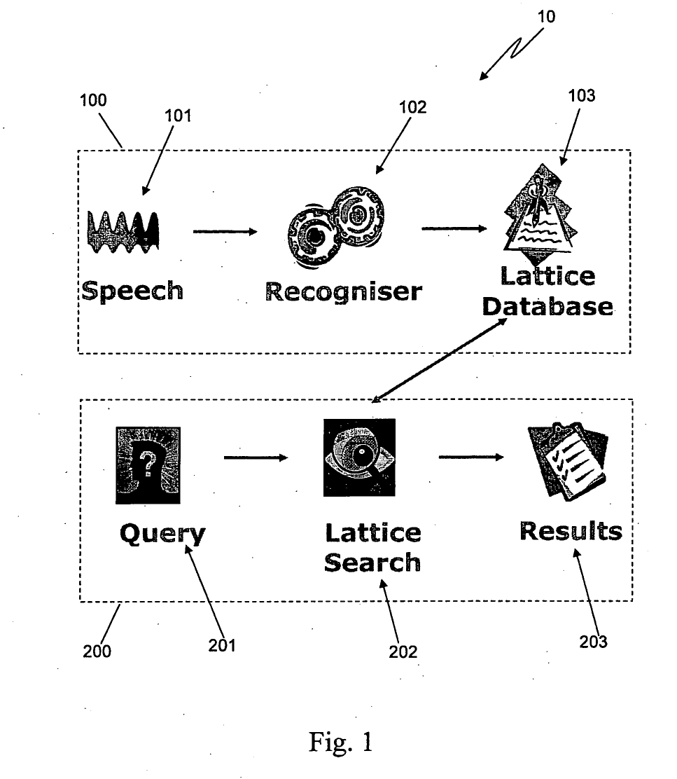

With reference to FIG. 1 there is illustrated the basic structure of a typical speech indexing system 10 of one embodiment of the invention. The system consists primarily of two distinct stages, a speech indexing stage 100 and a speech retrieval stage 200.

The speech indexing stage consists of three main components a library of speech files 101, a speech recognition engine 102 and a phone lattice database 103.

In order to generate the phone lattice 103 the speech files from the library of speech files 102 are passed through the recogniser 102. The recogniser 102 performs a feature extraction process to generate a feature-based representation of the speech file. A phone recognition network is then constructed via a number of available techniques, such as phone loop or phone sequence fragment loop wherein common M-Length phone grams are placed in parallel.

In order to produce the resulting phone lattice 103 an N-best decoding is then preformed. Such a decoding utilises the phone recognition network discussed above in conjunction with a well-trained set of acoustic models such as tri-phone Hidden Markov Models (HMM), and an appropriate language model such as an N-gram language model.

The lattice may then be further refined by performing a high order language expansion. An output beamwidth pruning operation may then be performed to remove paths from outside a predefined beamwidth of the top scoring path of the lattice.

In the speech retrieval stage 200, a user firstly inputs a query 201 into the systems search engine which then searches the lattice 202 for instances of the given query. The results 203 of the search are then displayed to the user.

Traditional retrieval methods perform an online lattice search during query time. Given a target phone sequence, a lattice can be traversed using standard lattice traversal techniques to locate instances of the target sequence within the complex lattice structure.

The standard lattice-based search algorithm can be summarised as follows. Let the target phone sequence be defined as P=(p₁, p₂, . . . , p_{N}) then let A={ } where A is the collection of matching sequences and Θ={θ₁ⁱ, θ₂ⁱ, . . . } be defined as the set of all N-length sequences θⁱ=(θ₁ⁱ,θ₂ⁱ, . . . ) that exist in the lattice, where each element θₖⁱ corresponds to a node in the lattice. Each node may have properties including node time, which is the time at which the node was generated in the associated speech utterance, and node label which is the associated label for the node (e.g. phone label).

The mapping function to map a node sequence to a phone symbol sequence is then defined as follows:
Φ(θⁱ)=(φ(θ₁ⁱ),φ(θ₂ⁱ), . . . ) (1)
where the function φ(x) returns the phone symbol for node x.

For each node i in the phone-lattice, where node list traversal is done in time-order, the subset of all node sequences that terminate at the current node are derived. This set is termed the observed sequence set and is defined as follows:
Q(Θ, i)={Q₁, Q₂, . . . }={θ^{k}∈Θ|θ_{N}^{k}=i} (2)

The members of the observed sequence that match the target phone sequence are then determined. The matching operation is performed using the matching operators \textcircled{x} as follows:
R(Q,P)={Qⁱ∈Q|Φ(Qⁱ)\textcircled{x}P} (3)

Since for the standard lattice-based search algorithm, the equality operation is used for matching sequences, then R(Q, P) can also be defined as:
R(Q,P)={Qⁱ∈Q|Φ(Qⁱ)=P} (4)

Any matching sequences are then appended to the set of matches for this lattice, using the update equation:
A=A∪R(Q,P) (5)
where output A is the set of putative matches. Timings of the matches can be easily derived from the node properties.

Searching through a lattice provides improvements for detection rates, compared to searching N-best transcriptions, since a sufficiently rich lattice provides multiple localised hypotheses at any given point in time. However, the lattice search task is computationally intensive, and although textual, still poses significant implications for the query-time execution speed. Accordingly the query-time execution speed may be improved by performing a significant portion of the lattice traversal offline during the speech indexing stage.

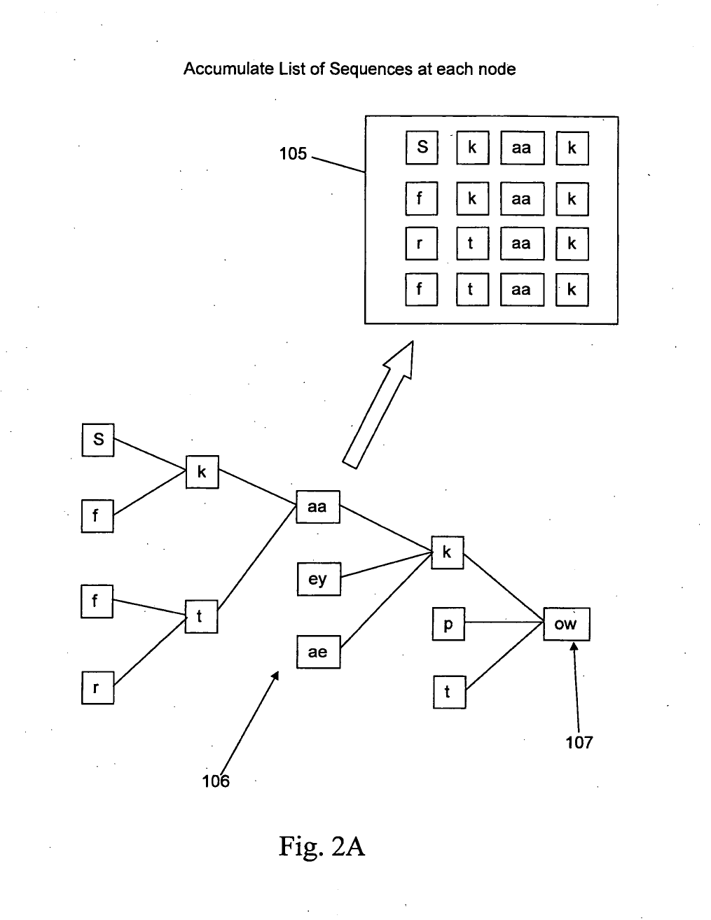

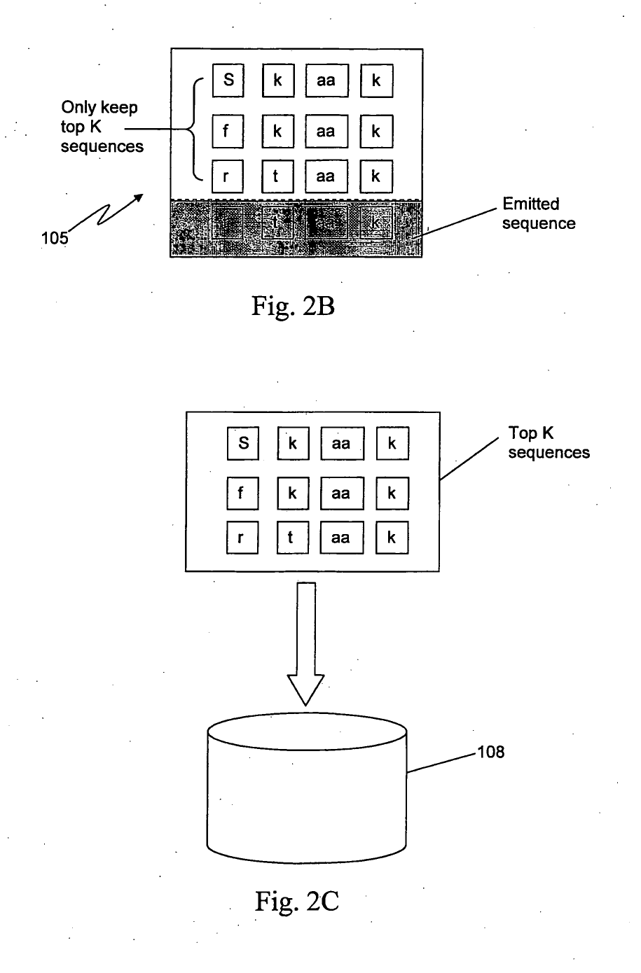

Since the paths traversed through the lattice are independent of the queried target sequences (traversal is done purely by maximum likelihood), it is possible to perform the actual lattice traversal during the indexing stage. That is, it is possible to obtain Q(Θ,i) for each node i during the indexing stage, since it is independent of the target sequence P. However, it is not possible to determine the set of target sequence matches, R(Q, P), since P is not known at the time of indexing. For example in FIG. 2A, a listing of possible occurrences Q(Θ,i) of the term stack is compiled 105 by traversing the lattice 106 backwards from node i 107.

The data storage requirements for storing Q(Θ,i) may be quite large particularly for very rich lattices. Thus in order to reduce the storage space required it is necessary to apply some constraints to restrict the size of Q(Θ,i). Instead of storing Q(Θ,i) a constrained sequence set Q′=(Θ,i,K) is used. This constrained sequence set is derived as discussed below.

Let H(θⁱ) be defined as the path likelihood of sequence θⁱ. This path likelihood can be computed from the lattice by traversing the path traced by θⁱ and accumulating the total acoustic and language likelihoods for this path. The sequence set Γ(Q) is then determined and is simply the sequence set Q ordered by the path likelihood and is given by:

$$\begin{matrix}\begin{matrix}Γ ( Q ) = ( {Γ}^{1} , {Γ}^{2} , … ) \\ = F ( DescSort \{ [ {Q}^{1} , H ( {Q}^{1} ) ] , [ {Q}^{2} , H ( {Q}^{2} ) ] , … \} ) ;\end{matrix} \\ where \text{:} & \begin{matrix}( 6 ) \\ ( 7 )\end{matrix} \\ F ( ( [ {x}_{1} , {y}_{1} ] , [ {x}_{2} , {y}_{2} ] , … ) ) = ( {x}_{1} , {x}_{2} , … ) & ( 8 ) \\ \begin{matrix}DescSort ( ( [ {x}_{1} , {y}_{1} ] , [ {x}_{2} , {y}_{2} ] , … ) ) = ( [ {m}_{1} , {n}_{1} ] , [ {m}_{2} , {n}_{2} ] … ) \\ = ( \begin{matrix}\begin{matrix}[ {m}_{i} , {n}_{i} ] , \\ m ∈ X ,\end{matrix} \\ n ∈ Y \text{\vert} {n}_{ i} \geq {n}_{ k} ∀ k > i\end{matrix} )\end{matrix} & \begin{matrix} ( 9 ) \\ ( 10 )\end{matrix}\end{matrix}$$

The reduced seq Γ′(Q) is then obtained by finding the subset of sequences in Γ(Q) that have unique phone symbol sequences. An element with a higher likelihood is always chosen when comparing two items with the same phone symbol sequence.

Finally, the constrained sequence set is derived as follows:
Q′(θ,i,K)={Γ^{k}∈Γ′(Q)|H(Γ^{k})≧H(Γ^{K})} (11)

Thus, the constrained sequence set Q′(Θ,i) will contain the K top scoring sequences based on the path likelihoods as shown in FIG. 2B. The resulting constrained sequence set is then stored in a sequence database 108 as shown in FIG. 2C.

However such an approach requires prior knowledge of the length of the target sequence. Since Θ represents the set of all, N-length sequences in a lattice, the value of N, must be known during the indexing stage. However, this can be easily solved by selecting Nₘₐₓ as the maximum length supported for target phone sequence queries. Then all Nₘₐₓ length sequences can be stored in the database and used for the retrieval of any target sequence that is shorter than Nₘₐₓ.

The sequence generation stage can then be performed for each lattice as follows. Let Nₘₐₓ be defined as the maximum length of target phone sequences that will be supported for speech retrieval and let K be defined as the maximum node sequence set size that will be stored for each node. Let A={ }, where A is the collection of nodes and let Θ=(θ₁,θ₂, . . . ) be the set of Nₘₐₓ-length sequences that occur within the lattice.

Then for each node i in the phone-lattice, where node list traversal is done in time-order, the set of Nₘₐₓ-length sequences terminating at this node, Q(Θ,i), is determined using equation 2 as detailed above. The constrained set of sequences terminating at this node, Q′(Θ,i,K) is then determined using equation 11 as above. The collection of node sequences, A=A∪Q′(Θ,i,K) is then updated. Next the ordered set of observed phone sequences B is determined in accordance with equation 12 below and the corresponding observed phone sequence times C is determined in accordance with equation 13 below.
B={Φ(Aⁱ)|Aⁱ∈A}
C={Y(Aⁱ)|Aⁱ∈A} (13)
where Y(Aⁱ) transforms the node sequence Aⁱ to the corresponding node time sequence. The node sequences A, the observed phone sequences collection, B and the phone sequence times collection C are then stored in the sequence database 108.

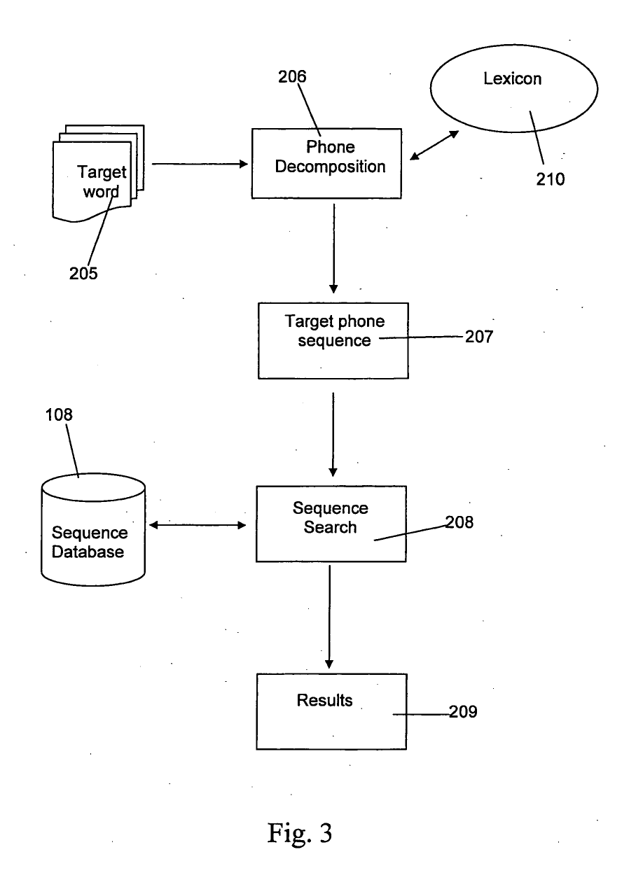

Thus retrieval process is significantly simplified. For each node i, R(Q, P) can quickly be computed by retrieving Q(Θ,i) from the sequence database 108 as shown in FIG. 3.

Firstly a desired target word 205 is obtained, a target phone sequence 207 is then derived by performing a phone decomposition operation 206 on the target word 205. Typically, the phone sequence representation can be obtained by simply performing a lookup in a lexicon 210 containing pronunciations for a cross-section of common words in the target language. The target phone sequence is then compared against the phone sequences Q(Θ,i) 208 stored in database 105 and the results output for display 209.

However, since the purpose of this speech indexing and retrieval system is to provide an unrestricted query vocabulary, it is not sufficient to assume that every target word will exist in the provided lexicon, no matter how large the lexicon. Thus, as a fallback, standard spelling-to-sound rules can be used to derive this phone decomposition. A number of well-established methods exist to perform this phone decomposition, including spelling-to-sound rules and heuristics. A number of simple techniques are reviewed in the paper by D. H. Klatt entitled “Review of text-to-speech conversion for English”, published in the Journal of the Acoustical Society of America vol. 82, pp 737-793, September 1987.

In order to further improve robustness of the system, the search operation in a further embodiment of the present invention is an extension of the search operation used in the standard phone lattice search. This search operation utilises the Minimum Edit Distance (MED) during the lattice search to compensate for phone recogniser errors.

The MED can be calculated using a Levenstein algorithm. A basic implementation of the Levenstein algorithm uses a cost matrix to accumulate transformation costs. A recursive process is desirably used to update successive elements of this matrix in order to discover the overall minimum transformation cost.

Let the sequence P=(p_{1, p}₂, . . . , p_{M}) be defined as the source sequence and the sequence Q(q₁, q₂, . . . , q_{N}) be defined as the target sequence. In addition three transformation cost functions are defined as follows:
Cₛ (x,y) represents the cost of transforming symbol x in P to symbol y in Q. Typically this has a cost of 0 if x=y i.e. a match operation;
Cᵢ(y) the cost of inserting symbol y into sequence P; and
C_{d}(x) the cost of deleting the symbol x from sequence P.

The element at row i and column j in the cost matrix represents the minimum cost of transforming the subsequence (pₖ)₁ⁱ to (qₖ)₁^{j}. Hence the bottom-right element of the cost matrix represents the total minimum cost of transforming the entire source sequence P to the target sequence Q.

The basic premise of the Levenstein algorithm is that the minimum cost of transforming the sequence (pₖ)₁ⁱ to (qₖ)₁^{j} is any of:
1. The cost of transforming (pₖ)₁ⁱ to (qₖ)₁^{j-1} plus the cost of inserting qⱼ;
2. The cost of transforming (pₖ)₁ⁱ⁻¹ to (qₖ)₁^{j} plus the cost of deleting pᵢ;
3. The cost of transforming (pₖ)₁ⁱ⁻¹ to (qₖ)₁^{j-1} plus the cost of substituting pᵢ with qⱼ. If pᵢ=qⱼ then this is usually taken to have a cost of 0.

In this way, the cost matrix can be filled from the top-left corner to the bottom-right corner in an iterative fashion. The Levenstein algorithm is then as follows:
1. Initialise a (M+1)×(N+1) matrix Ω. This is called the Levenstein cost matrix.
2. The top left element Ω^{0,0} represents the cost of transforming the empty sequence to the empty sequence; this is therefore initialised to 0
3. The first row of the cost matrix represents the sequence of successive insertions. Hence it can be initialsed to be:
   Ω_{0,j}=Ω_{0,j-1}+Cᵢ(qⱼ)
4. The first column of the cost matrix represents successive deletions. It therefore can also be immediately initialised to be:
   Ω_{i,0}=Ω_{i-1,0}+C_{d}(pᵢ)
5. Update elements of the cost matrix from the top-left down to the bottom-right using the Levenstien update equation:

$${Ω}_{i , j} = Min ( \begin{matrix}{Ω}_{i , j - 1} + {C}_{i} ( {q}_{j} ) , \\ {Ω}_{i - 1 , j} + {C}_{d} ( {p}_{i} ) , \\ {Ω}_{i - 1 , j - 1} + {C}_{s} ( {p}_{i} , {q}_{j} )\end{matrix} )$$

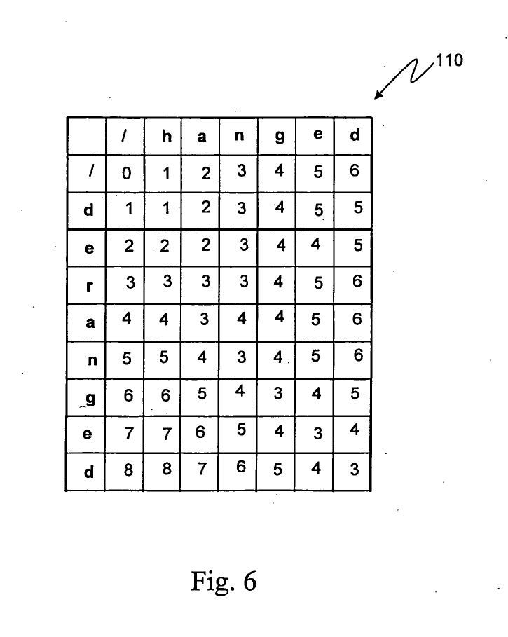

FIG. 6 shows an example of a cost matrix 110 obtained using the MED method for transforming the word “deranged” to the word “hanged” using constant transformation functions. It shows that the cheapest transformation cost is 3. There are multiple means of obtaining this minimum cost. For example, both the operation sequences (del, del, subst, match, match, match, match, match) and (subst, del, del, match, match, match, match, match) have costs of 3.

Given source and target sequences, the MED calculates the minimum cost of transforming the source sequence to the target sequence using a combination of insertion, deletion, substitution and match operations, where each operation has an associated cost. In this embodiment of the invention, each observed lattice phone sequence is scored against the target phone sequence using the MED. Lattice sequences are then accepted or rejected by thresholding on the MED score, hence providing robustness against phone recogniser errors. The standard lattice search is a special case of this embodiment of the invention where a threshold of 0 is used.

Let P=(p₁, p₂, . . . , p_{N}) be defined as the target phone sequence, where N is the target phone sequence length. In addition let Sₘₐₓ be the maximum MED score threshold, K be the maximum number of observed phone sequences to be emitted at each node, and V be defined as the number of tokens used during lattice traversal. Then for each node in the phone-lattice, where node list traversal is done in time-order, then for each token in the top K scoring tokens in the current node let Q=(q₁, . . . , q_{M}), M=N+MAX(Cᵢ)×Sₘₐₓ be the observed phone sequence obtained by traversing the token history backwards M levels, where Cᵢ is the insertion MED cost function.

Let S=BESTMED(Q,P,Cᵢ,C_{d},Cₛ), where C_{d} is the deletion cost function, Cᵢ is the substitution cost functions, and BESTMED( . . . ) returns the score of the first element in the last column of the MED cost matrix that is ≦Sₘₐₓ (or ∞ otherwise). Then emit Q as a keyword occurrences if S≦Sₘₐₓ. For each node linked to the current node, perform V-best token set merging of the current node's token set into the target node's token set.

A number of optimisations can be used to improve throughput of this search process. In particular, MED calculations can be aggressively optimised to reduce processing time. One such optimisation is to only calculate successive columns of the MED matrix if the minimum element of the current column is less than Sₘₐₓ, since by definition the minimum of a MED matrix column is always greater than or equal to the minimum of the previous column.

Another optimisation is the removal of lattice traversal from query-time processing. Since the paths traversed through the lattice are independent of the queried phone sequence (traversal is done purely by maximum likelihood), it is possible to perform the lattice traversal during the speech preparation stage and hence only store the observed phone sequences at each node for searching at query-time. Therefore, if the maximum query phone sequence length is fixed at Nₘₐₓ and the maximum sequence match score is preset at Sₘₐₓ, it is only necessary to store observed phone sequences of length Mₘₐₓ=Nₘₐₓ+MAX(Cᵢ)×Sₘₐₓ for searching at query time. Query-time processing then reduces to simply calculating the MED between each stored observed phone sequence Q(Θ,i) and the target phone sequence P=(p₁, p₂, . . . p_{N}).

This optimisation results in a significant reduction in the complexity of query-time processing. Whereas in the previous approach, full Viterbi traversal was required, processing using this optimised approach is now a linear progression through a set of observed phone sequences. The improved lattice building algorithm is as follows.

Firstly the recognition lattice is constructed using the same approach as in the basic method discussed above. Let A={ }, where A is the collection of observed phone sequences. For each node in the phone-lattice, where node list traversal is done in time-order, for each token in the top K scoring tokens in the current node, let Q=(q₁, . . . , q_{Mmax}) be the observed phone sequence obtained by traversing the token history backwards Mₘₐₓ levels. The sequence Q is the appended to the collection A, for each node linked to the current node perform V-best token set merging of the current node's token set into the target node's token set. The observed phone sequence collection is the stored for subsequent searching.

The recognition lattice can now be discarded as it is no longer required for query-time searching, this allows the considerably simpler query time search algorithm. Firstly the previously computed observed phone sequence collection for the current utterance then for each member, Q of the collection of observation sequences, A Let S=BESTMED(Q,P,Ci,Cd,Cs) then emit Q as a putative occurrence if S≦Sₘₐₓ.

Both of the above discussed algorithms utilise a Minimum Edit Distance (or Levenstien distance) Cost matrix. The Levenstein distance measures the minimum cost of transforming one string to another. Transformation is performed by successive applications of one of four transformations matching, substitution, insertion and deletion. Typically, each transformation has an associated cost, and hence implicitly the Levenstein algorithm must discover which sequence of transformations results in the cheapest total transformation cost.

In a further embodiment of the present invention the sequences stored within the sequence database may be grouped together to form what the applicant calls hypersequences using a number of predefined criteria.

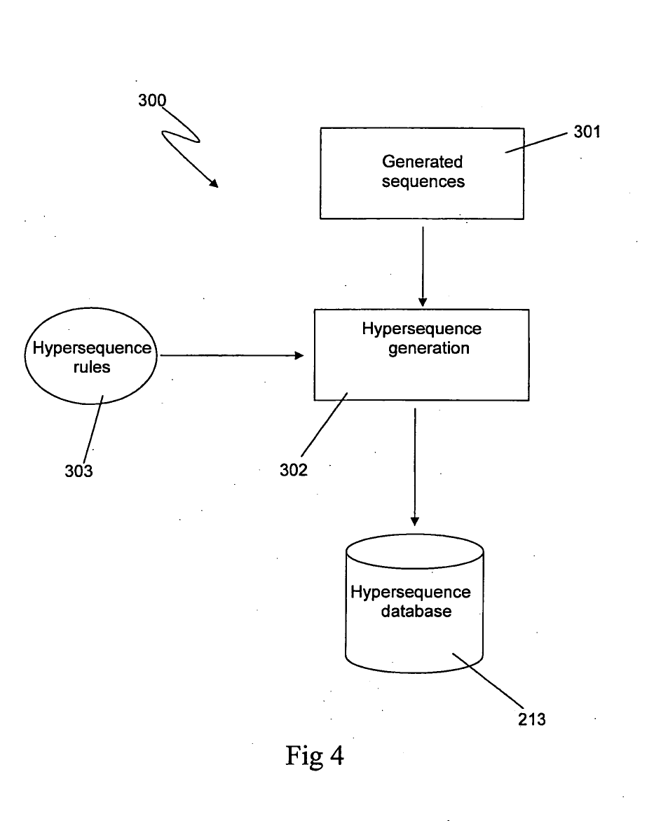

FIG. 4 illustrates the basic hypersequence generation process 300, here the set of observed sequences 301 generated during the sequence generation process discussed above are grouped together to form a set of hypersequences 302 in accordance with number of predefined criteria (hypersequence rules) 303. The resulting set of observed hypersequences are then stored the hypersequence database 213.

A single hypersequence may then be used to represent each group of sequences. If a sensible hypersequence mapping is used, then at search time, it is possible to simply search the hypersequence database to identify which hypersequences (and thus which corresponding groups of sequences) are most likely to yield a match for the target sequence.

In this way, the sequence database can be represented using a hierarchical structure. Since a hierarchically structured database can be more efficiently searched than a flat structured database, the entire speech retrieval process becomes significantly faster and thus more scalable for large database search tasks.

A significant factor that affects the overall performance gain in hypersequence based searching is the structure of the hypersequence mapping. Let Ξ(θ) be defined as a hypersequence mapping that maps a sequence θ to its corresponding hypersequence [symbol] . In order to produce a hypersequence domain that has a smaller search space than the sequence database, the mapping Ξ must be an N→1 mapping. Thus the inverse mapping Ξ⁻¹ ( [symbol] ) which maps a hyper sequence to its set of associated sequences (or hypersequence cluster) must be a 1→N mapping.

The hypersequence mapping can thus be considered as a compressing transform, with a compression factor δ. The larger the value of a the more restricted hypersequence search space which results in a faster hypersequence database search. However, too large a value of δ results in a very large number of sequences being associated with each hypersequence, thus resulting in a greater amount of subsequence processing required during the refined search of the sequence database.

Thus the mapping function Ξ(θ) should be selected such that it provides a compromise between domain compression and the average size of the resulting hypersequence sequence clusters. In this particular instance a sequence is mapped to a hypersequence on a per-element basis. That is, given a sequence θ of length N a hypersequence is generated by performing a per-element mapping of each element of θ to result in a hypersequence of length N. Thus the hypersequence transform has the following form:
Ξ(θ^{k})=(ξ(θ₁^{k}),ε(θ₂^{k}), . . . ε(θ_{N}^{k})) 14

Then development of the hypersequence transform reduces to a careful selection of the form of the element mapping function ε(x). A number of forms for this element mapping function may be applied a number of which are detailed below.

The first is a linguistic knowledge based mapping. Here mapping rules are derived using well-defined classings from linguistic knowledge. For example, a valid mapping function may be to map all phones to one to their most representative linguistic class, such as vowels, fricatives, nasals, etc. as shown in table I below.

TABLE I
Linguistic-based hypersequence mapping function Θⱼ^{k} = ξ(θⱼ^{k})

| θⱼ^{k} | Θⱼ^{k} |
|---|---|
| aa, ae, ah, ao, aw, ax, ay | Vowel |
| eh, en, er, ey | |
| ih, iy | |
| ow, oy | |
| uh, uw | |
| b, d, g, k, p, t | Closure/Stop |
| ch, f, jh, s, sh, v, z, zh | Fricative |
| hh, l, r, w, wh, y | Glide |
| m, n, nx | Nasal |

The second form of the element mapping is a data driven acoustic mapping. In this form of the mapping, the appropriate rules are derived using an acoustic-based clustering approach. For example, a maximum likelihood decision-tree clustering approach can be used to derive a set of clusterings for phones, which can then be translated into a rule-based mapping. A similar approach is used for deriving tri-phone mappings in tri-phone decision-tree clustering.

The third approach is a context dependent mapping. Incorporating context restricts mapping rules in this manner is more theoretically correct, but results in a larger number of target hypersequence symbols, and thus a much smaller hypersequence domain compression factor. It should be noted that both the linguistic knowledge based and data driven acoustic mapping can be constructed in a context dependent or context independent fashion.

Once a valid hypersequence function Ξ(θ), has been selected, the hypersequence database can then be generated as follows. Firstly the inverse hypersequence mapping function Ξ⁻¹( [symbol] ^{k}) is initialised to be a null mapping function defined by:
∀ [symbol] Ξ⁻¹( [symbol] )={ } (15)

For each node sequence, A^{k}, in the sequence database A the corresponding hypersequence is obtained using: [symbol]
^{k=Ξ(Φ(}A^{k})) (16)

The inverse hypersequence mapping function is then updated in accordance with:
Ξ⁻¹( [symbol] ^{k})=Ξ⁻¹( [symbol] ^{k})∪{A^{k}} (17)
the resulting inverse hypersequence mapping function is then stored to disk for use during speech retrieval stage.

A unique list of hypersequences D is then generated, the list is simply the domain of the inverse mapping function defined as follows:
D=dom{Ξ⁻¹( [symbol] ^{k})} (18)

The hypersequence collection, D, is then stored to disk for use during speech retrieval stage.

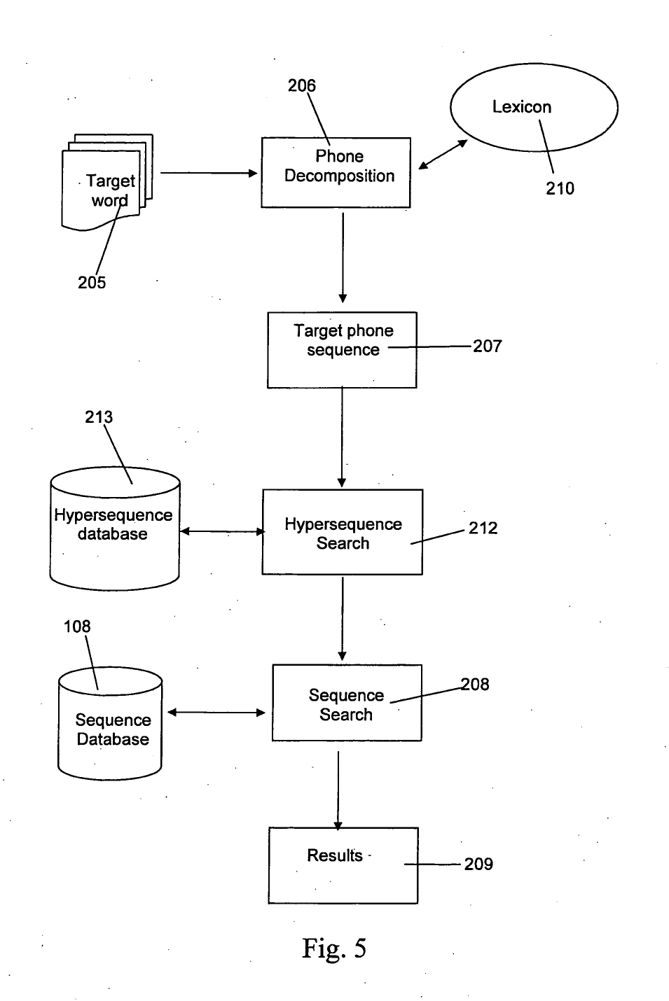

The retrieval process, as shown in FIG. 5 firstly involves obtaining the target word 205 and then producing the target phone sequence 207 by performing a phone decomposition 206 on a given target word. A crude search 212 is the preformed on the constrained domain hypersequence database 213, and the associated sequence clusters of any matching hypersequences corresponding to a set of target phone sequences P={p₁, p₂, . . . } are then emitted 214 as discussed below.

For each target phone sequence, p the equivalent target hypersequence p′=Ξ(Φ(p)) is determined.

The set of candidate sequence function is initialised to be a null function Π(p)={ }. Then for each hypersequence d in the domain set D of the hypersequence inverse mapping function Ξ⁻¹( [symbol] ^{k}), calculate the sequence distance Δ(d, p′). Sequence distance can be calculated using one of the many approaches described in detail below. A number of experiments conducted by the applicant have demonstrated that a simple equality-based distance function is sufficient to retrieve a significant portion of the correct candidate sequences, however, more complex distance functions provide greater control on the retrieval accuracy of the overall system.

If the sequence distance is within the hypersequence emission threshold, δ, then update the candidate sequence function to include the corresponding sequence cluster using:
Π(p)=Π(p)∪Ξ⁻¹(d) (19)

The final candidate sequence function Π(p), is then outputted. This outputted set of sequences then undergoes the refined sequence search briefly mentioned above.

The refined search 208 is conducted on the candidate sequence function, Π(p)={Π(p₁), Π(p₂), . . . } in order to better identify the correct instances of the target phone sequences, P={p₁, p₂, . . . }.

Such a search process can be performed by evaluating the set of sequence distances between each member of Π(pᵢ) and the corresponding target sequence pᵢ, and emitting only those sequences that are within a predefined acceptance threshold, δ′ in accordance with the following algorithm.

For each target sequence, pᵢ the set of candidate sequences function is initialised as a null function Π′(p)={ } and the candidate sequence set Π(pᵢ) obtained using the hyper sequence search. Then for each member π, of Π(pᵢ) evaluate the sequence distance Δ(Φ(π), pᵢ) and emit the sequence π, as a candidate if its distance Δ(Φ(π), pᵢ) is within the sequence acceptance threshold δ′ wherein:
Π′(pᵢ)=Π′(pᵢ)∪{π} (20)

The final result set is then obtain using:
R(pᵢ)={(Φ(π₁), Y(π₁)),(Φ(π₂),Y(π₂)), . . . } (21)
where Φ(π) is the phone symbol sequence of πᵢ and Y(πᵢ) is the timing information for π obtained from the phone sequence times collection C.

Thus the output 209 of this stage is a set of refined results, R={R(p₁), R(p₂), . . . }, containing matched phone symbol sequences and corresponding timing information.

As discussed both the hypersequence database search and sequence database search stages in this particular instance utilise the sequence distance to obtain a measure of the similarity between a candidate sequence and a target sequence. There are a number of methods that can be used to evaluate sequence distance. For example traditional lattice-based search methods use an equality-based distance function. That is, the sequence distance function is formulated as:

$$\begin{matrix}Δ ( A , B ) = \{ \begin{matrix}{\sum }_{i = 1}^{N} eq ( {a}_{i} , {b}_{i} ) = N , & 0 \\ otherwise , & ∞\end{matrix} & ( 22 ) \\ where eq ( x , y ) = \{ \begin{matrix}a = b , & 1 \\ otherwise , & 0\end{matrix} & ( 23 )\end{matrix}$$

Unfortunately, this type of distance measure does not provide suitable robustness to erroneous lattice realisations. Since the phone recognition is highly erroneous (quoted error rates are typically in the vicinity of 30 to 50%), it is quite probable that a true instance of a target phone sequence will actually be realised erroneously with substitution, insertion or deletion errors.

As discussed above in order to improve robustness to lattice errors the Minimum Edit Distance (MED) algorithm is used to determine the cost of transforming an observed lattice sequence to the target sequence. This cost is indicative of the distance between the two sequences, and thus provides a measure of similarity between the observed lattice sequence and the target sequence.

Thus, the sequence distance for speech retrieval stage in this particular embodiment can be formulated as follows:
Δ(A,B)=BESTMED(A,B,Cᵢ⁻¹,C_{d}⁻¹,Cₛ) (24)
where
Cᵢ⁻¹=insertion cost function
C_{d}⁻¹=delection cost function
Cₛ=substition cost function
BESTMED( . . . )=the minimum score of the last column of the MED cost matrix

It should be noted that in this instance the inverse cost functions Cᵢ⁻¹ and C_{d}⁻¹ have been use as opposed to the cost functions Cᵢ and C_{d} as discussed above. This is because it is more natural within the context of this speech retrieval algorithm to consider the insertion function as corresponding to the cost of assuming that an insertion error occurred in the source sequence (i.e. the phone sequence from the recogniser). This corresponds to a deletion within conventional MED framework, represented by the cost function C_{d} . Similarly, it is more natural to consider the deletion function as corresponding to a deletion error within the source sequence, which corresponds to an insertion in the conventional MED framework.

Accordingly within the context of this embodiment of the invention with or without hypersequence searching, the insertion function refers to the inverse cost function Cᵢ⁻¹=C_{d} and the deletion function refers to the inverse cost function C_{d}⁻=Cᵢ.

The quality of the distance function is dependent on the three cost functions, Cᵢ⁻¹, C_{d}⁻¹, and Cₛ. During experimentation the applicant found that it was useful to set either the insertion cost or deletion cost functions to ∞ to prevent a substitution error being mimicked by a combination of insertion and deletion. Additionally, it was found that using an infinite deletion cost function lead to a slight improvement in detection performance, and thus, C_{d}⁻¹(x)=∞ is used.

The insertion and substitution cost functions may then be derived in one of two fashions. The first is via the use of knowledge based linguistic rules. Under this method a set of rules are obtained using a combination of linguistic knowledge and observations regarding confusion of phones within the phone recogniser. For example, it is probable that the stop phones |b|, |d|, and |p| are likely to be confused by a recogniser and thus there would be a small substitution cost. In contrast, it is less likely that a stop phone would be confused with a vowel phone, and thus this substitution would have a correspondingly higher cost.

Thus, through careful selection and experimentation, it is possible to craft a set of rules that can be used to represent both the insertion and substitution cost functions. For example a well-performing system was built using a fixed insertion cost function of Cᵢ⁻¹(x)=1 and a variable substitution cost function as shown in table II below:

TABLE II
Rule-based substitution costs
(a) Rules used to derive phone substitution costs

| Rule | Cost |
|---|---|
| same-letter consonant phone substitution | 0 |
| `eg. [symbol] | |
| vowel substitutions | 1 |
| closure and stop substitutions | 1 |
| all other substitutions | ∞ |

(b) Actual phone substitution costs

| Phones | Cost | Phones | Cost |
|---|---|---|---|
| aa ae ah ao aw ax ay | 1 | d dh | 0 |
| eh en er ey ih iy | | n nx | 0 |
| ow oy uh uw | | t th | 0 |
| b d dh g k p t th jh | 1 | uw w | 1 |
| z zh s sh | 1 | w wh | 0 |

The alternative approach for deriving the required cost functions is to estimate probabilistically based representations estimated from a set of development data. In this instance the estimation was based on the phone recogniser confusion matrix which can be generated by comparing transcripts hypothesised by the recogniser to a given set of reference transcripts.

Given a confusion matrix, a number of base statistics can be calculated. The following derivation uses the events defined below.
Eₓ: phone x was emitted by the regoniser (25)
R_{c}: phone x was in the reference transcript (26)

Thus the elements of the confusion matrix, Γ can be defined as:
Γ(x,y)=p(Eₓ|R_{y}) (27)

The unconditional probabilities P(Eₓ) and P(R_{y}) can be computed from the confusion matrix in accordance with the following:
P(R_{y})=Σₓp(Eₓ|R_{y}) (28)
P(Eₓ)=Σ_{y}p(Eₓ|R_{y})P(R_{y}) (29)

Thus it is possible to obtain the substitution probability using Bayes theorem, as follows:

$$\begin{matrix}\begin{matrix}p ( {R}_{y} \text{\vert} {E}_{x} ) = \frac{p ( {E}_{x} \text{\vert} {R}_{y} ) P ( {R}_{y} )}{P ( {E}_{x} )} \\ \end{matrix} & ( 30 ) \\ = \frac{p ( {E}_{x} \text{\vert} {R}_{y} ) {\sum }_{i} p ( {E}_{i} \text{\vert} {R}_{y} )}{ {\sum }_{j} \{ p ( {E}_{x} \text{\vert} {R}_{j} ) {\sum }_{k} p ( {E}_{k} \text{\vert} {R}_{j} ) \}} & ( 31 )\end{matrix}$$

which is the likelihood that the reference phone was y given that the phone recogniser output the phone x. This provides a basis for the subsequent derivation of the substitution cost function.

The insertion probability p(Iₓ) can be simply computed by counting the number of times the phone x is inserted in the hypothesised transcriptions with respect to the set of reference transcripts.

Given these probabilities, the required cost functions, Cₛ(x, y) and Cᵢ⁻¹(x) can then be computed using a number of approaches, as discussed below.
a) Information-theoretic: Here the information of a given event is used to represent its cost. The information of an event is representative of the uncertainty of the event, and thus an indication of the cost that should be incurred if the event occurs. Thus an event with a high level of uncertainty will be penalised more severely than a common event.

From information theory, the information of a given event is given by:
I(x)=−log p(X) (32)

Thus, the required cost functions can derived as follows:

$$\begin{matrix}\begin{matrix}{C}_{s} ( x , y ) = I ( {R}_{y} \text{\vert} {E}_{x} ) \\ = - log p ( {R}_{y} \text{\vert} {E}_{x} ) \\ = - log \frac{p ( {E}_{x} \text{\vert} {R}_{y} ) {\sum }_{i} p ( {E}_{i} \text{\vert} {R}_{y} )}{{\sum }_{j} \{ p ( {E}_{x} \text{\vert} {R}_{j} ) {\sum }_{k} p ( {E}_{k} \text{\vert} {R}_{j} ) \}}\end{matrix} & \begin{matrix}( 33 ) \\ ( 34 ) \\ ( 35 )\end{matrix} \\ \begin{matrix}{C}_{i}^{- 1} ( x ) = I ( {I}_{x} ) \\ = - log p ( {I}_{x} )\end{matrix} & \begin{matrix}( 36 ) \\ ( 37 )\end{matrix}\end{matrix}$$

This approach may be further extended to use the mutual information I(x; y), relative entropy, or other information-theoretic concepts.
b) Affine transform: An alternative means of deriving the cost functions from the given conditional event probabilities is to simply apply a numerical transform. The cost of an event can be said to be inversely proportional to the likelihood of its occurrence, and thus, a variety of decreasing functions could be used to transform the given conditional probabilities to the required costs.

The types of functions that could be used to perform this transformation include:
a) The negative exponential, Ae^{-b(x-c)};
b) The tangent function, −A tan b(x−c);
c) The inverse function,

$$\frac{A}{b ( x - c )} .$$

For example, using the negative exponential, the substitution cost function is given by:

$$\begin{matrix}{C}_{s} ( x , y ) = A {ⅇ}^{- b ( p ( ( R y \vert {E}_{x} ) - c )} \\ = A exp - b ( \frac{p ( E x \text{\vert} R y ) {\sum }_{i} p ( {E}_{i} \text{\vert} R y )}{{\sum }_{j} \{ p ( E x \text{\vert} R j ) {\sum }_{k} p ( E k \text{\vert} R j \}} - c )\end{matrix} \qquad \begin{matrix}( 38 ) \\ ( 39 )\end{matrix}$$

where the parameters A, b and c need to be tuned appropriately.

Both the knowledge-based and data-driven approaches described above have been shown by experimentation to estimate robust MED distances. However, both approaches are approximations of a true cost function: the knowledge based approach is based on human derived rules which are clearly prone to error, while the data-driven approach is based on a confusion matrix which is estimated from a development data set.

Thus both approaches are suboptimal and are prone to error. To reduce the effects of this error, fusion can be used to obtain a hopefully more robust cost function estimate. A linear fusion approach is used to derive an overall fused substitution cost function of the form:
Cₛf(x,y)=αCₛa(x,y)=(1−α) Cₛb(x,y) (40)
where Cₛa(x, y) and Cₛb(x, y) are the two candidate substitution cost functions to be fused.

The quality of the resulting fused function will depend on two important factors: the amount of complimentary information between the candidate functions, and the choice of the fusion coefficient. The amount of complimentary information is most appropriately measured qualitatively by experimentation. However, the selection of the fusion coefficient can be done using a number of standard approaches, including gradient descent or expectation maximisation.

The above derivations of cost functions have focused on a context-independent cost function. That is, the value of the cost function is only dependent on the hypothesised phone and the reference phone.

However, it is an established fact that the types of phone substitution that occur are typically well correlated with the context in which the event is present. That is, there is a considerable amount of dependence between the current hypothesised phone, the set of previously hypothesised and reference phones, and the set of following hypothesised and reference phones. Thus, there is likely to be a considerable improvement in the quality of the cost functions if contextual information is incorporated into the process.

One approach to incorporating context into the cost function is to only include the short term hypothesised phone context. To facilitate this derivation, the following notation is used:
Eₓ(t)=phone x was emitted by regoniser at time t (41)
Rₓ(t)=phone x was in the reference transcription at time t (42)

Then, the contextual event likelihoods required for estimating the necessary cost functions are:

$$p ( {R}_{y} ( t ) \text{\vert} {E}_{a} ( t - 1 ) , {E}_{b} ( t ) , {E}_{c} ( t + 1 ) ) = \frac{p ( {E}_{a} ( t - 1 ) , {E}_{b} ( t ) , {E}_{c} ( t + 1 ) \text{\vert} {R}_{y} ( t ) ) P ( {R}_{y} ( t ) )}{P ( {E}_{a} ( t - 1 ) , {E}_{b} ( t ) , {E}_{c} ( t + 1 ) )} \qquad ( 43 )$$

if only single phone context is used. The required probabilities p(Eₐ(t−1), E_{b}(t), E_{c}(t+1)|Ry(t)), and P(Eₐ(t−1), E_{b}(t), E_{c}(t+1)) can be easily computed using the context dependent counts from the confusion matrix.

Clearly, the above formulation can be extended to longer contexts if sufficient data is available to maintain robustness in the estimates. However, this introduces additional complexity into the computation of the function during MED scoring and may thus reduce the overall speed of speech retrieval.

Further gains in throughput can be obtained through optimisation of the MED calculations. MED calculations are in fact the mostly costly operations performed during the search stage. The basic MED algorithm is an O(N²) algorithm and hence not particularly suitable for high-speed calculation. However, within the context of this embodiment of the invention, a number of optimisations can be applied to reduce the computational cost of these MED calculations. These optimisations include the prefix sequence optimisation and the early stopping optimisation.

The prefix sequence optimisation utilises the similarities in the MED cost matrix of two observed phone sequences that share a common prefix sequence.

Let A=(a₁,a₂, . . ,a_{N}) and B=(b₁,b₂, . . . ,b_{M}). Also let B′ be defined as the first order prefix sequence of B, given by B′=(bᵢ)₁^{M-1}. Finally, let the MED cost matrix between two sequences be defined as Ω(X,Y).

From the basic definition of the MED cost matrix, the (N+1)×M cost matrix Ω(A,B′) is equal to the first M columns of the cost matrix Ω(A,B). This is because B′ is equal to the first M−1 elements of B.

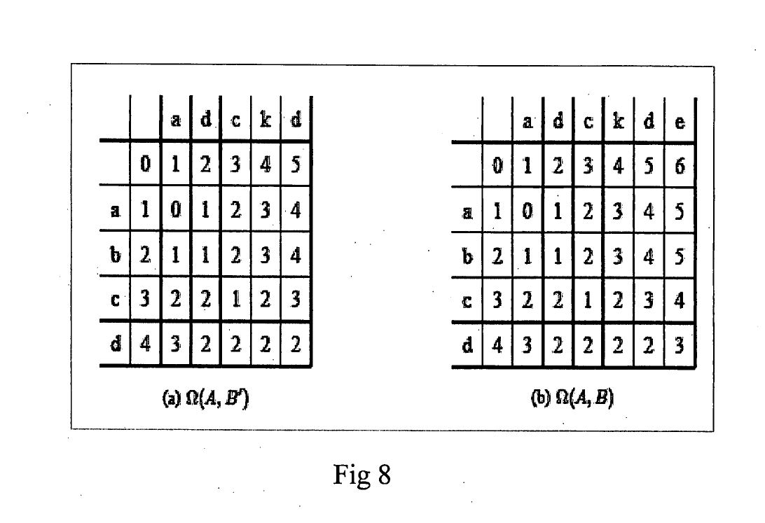

Therefore given the cost matrix Ω(A,B′), it is only necessary to calculate the values of the (M+1)th column of Ω(A,B) as shown in FIG. 8. The argument extends to even shorter prefix sequences of B. For example, let B^{m} be defined as the third-order prefix sequence of B, given by B^{m}=(bᵢ)₁^{M-3}. Then given Ω(A,B^{m}), it is only necessary to calculate the values of the (M−1)th, Mth and (M+1)th columns of Ω(A,B) to obtain the full cost matrix.

Now, given that the MED cost matrix Ω(A,B) is known, consider the task of calculating the MED cost matrix Ω(A,C). Let P(B,C) return the longest prefix sequence of B that is also a prefix sequence of C. Then, Ω(A,C) can be obtained by taking Ω(A,B) and recalculating the last |C|−|P(B,C) columns.

In the case of the present invention, an utterance is represented by a collection of observed phone sequences. Typically, there is a degree of prefix similarity between sequences from the same temporal location, and in particular between sequences emitted from the same node. As demonstrated above, knowledge of prefix similarity will allow a significant reduction in the number of MED calculations required.

The simplest means of obtaining this knowledge is to simply sort the phone sequences of an utterance lexically during the lattice building stage. Then the degree of prefix similarity between each sequence and it's predecessor can be calculated and stored. For this purpose, the degree of prefix similarity is defined as the length of the longest common prefix subsequence of two sequences.

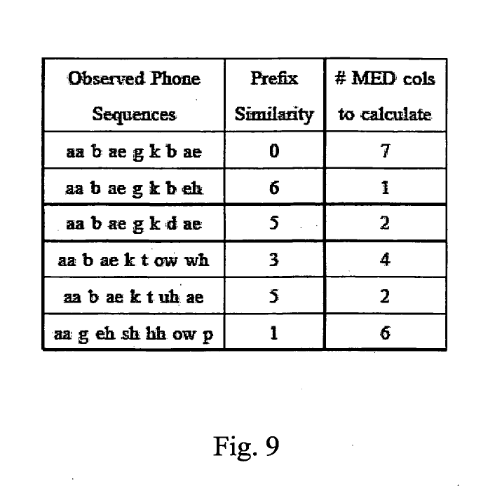

Then, during the search stage, all that is required is to step through the sequence collection and use the predetermined prefix similarity value to determine what portion of the MED cost matrix needs to be calculated, as demonstrated in FIG. 9. As such, only changed portions of the MED cost matrix are iteratively updated, greatly reducing computational burden.

The early stopping optimisation uses knowledge about the Sₘₐₓ threshold to limit the extent of the MED matrix that has to be calculated. From MED theory, the element Ω(X,Y)_{i,j} of the MED cost matrix Ω(X,Y) corresponds to the minimum cost of transforming the sequence (x)₁ⁱ to the sequence (y)₁^{j}. For convenience, the notation Ω id used to represent Ω(X,Y). The value of Ω_{i,j} is given by the recursive operation:

$${Ω}_{i , j} = Min ( \begin{matrix}{Ω}_{i - 1 , j - 1} + {C}_{s} ( {x}_{i} , {y}_{j} ) , \\ {Ω}_{i - 1 , j} + {C}_{d} ( {x}_{i} ) , \\ {Ω}_{i , j - 1} + {C}_{i} ( {y}_{j} )\end{matrix} ) \qquad ( 44 )$$

Given the above formulation, and assuming non-negative cost functions, the value of Ω_{i,j} has a lower bound (LB) governed by:
LB(Ω_{i,j})≧Min({Ω_{k,j}}ₖ₌₁ⁱ⁻¹∪{Ω_{k,j-1}}ₖ₌₁^{|X|}) (45)

That is, it is bounded by the minimum value of column j−1 and all values above row i in column j. This states that the lower bound of Ω_{i,j} is a function of Ω_{i-1,j}, which implies:
LB(Ω_{i,j})≧Min({LB(Ω_{i-1,j})}∪{Ω_{k,j-1}}ₖ₌₁^{|X|}) (46)

This states that the lower bound of Ω_{i,j} is governed by all entries in the previous column and the lower bound of the element directly above it in the cost matrix. If the recursion is continuously unrolled, then the lower bound reduces to being only a function of the previous column and the very first element in column j, that is:
LB(Ω_{i,j})≧Min({LB(Ω_{1,j})}∪{Ω_{k,j-1}}ₖ₌₁^{|X|}) (47)

Now MED theory states that Ω_{i,j}=Ω_{i,j}+Cᵢ(yⱼ) for all values of j. This means that for a positive insertion cost function:
LB(Ω_{i,j})≧LB(Ω_{i,j-1}) (48)

Substituting this back into equation 17 gives:
LB(Ω_{i,j})≧Min({LB(Ω_{i,j-1})}∪{Ω_{k,j-1}}ₖ₌₁^{|X|}) (49)

This reduces to the simple relationship:
LB(Ω_{i,j})≧Min({LB(Ω_{i-1,j})}∪{Ω_{k,j-1}}ₖ₌₁^{|X|}) (46)
LB(Ω_{i,j})≧Min({Ω_{k,j-1}}ₖ₌₁^{|X|}) (50)

It has therefore been demonstrated that the lower bound of Ω_{i,j} is only a function of the values of the previous column of the MED matrix. This lends itself to a significant optimisation within the framework of the present invention.

Since Sₘₐₓ is fixed prior to the search, there is an upper bound on the MED score of observed phone sequences that are to be considered as putative hits. When calculating columns of the MED matrix, the relationship in equation 52 can be used to predict what the lower bound of the current column is. If this lower bound exceeds Sₘₐₓ then it is not necessary to calculate the current or any subsequent columns of the cost matrix, since all elements will exceed Sₘₐₓ.

This is a very powerful optimisation, particularly when comparing two sequences that are very different. It means that in many cases only the first few columns will need to be calculated before it can be declared that a sequence is not a putative occurrence.

The early stopping optimisation and the prefix sequence optimisation can be easily combined to give even greater speed improvements. Essentially the prefix sequence optimisation uses prior information to eliminate computation of the starting columns of the cost matrix, while the early stopping optimisation uses prior information to prevent unnecessary computation of the final columns of the cost matrix. When combined, all that remains during MED costing is to calculate the necessary in-between columns of the cost matrix.

In the combined algorithm the first step is to initialise a MED cost matrix of size (N+1)×(M+1), where N is the length of the target phone sequence and M is the maximum length of the observed phone sequences. Then for each sequence in the observed sequence collection let k be defined as the previously computed degree of prefix similarity metric between this sequence and the previous sequence. Using the prefix sequence optimisation, it is only necessary to update the trailing columns of the MED matrix. Thus, for each column, j, from (M+1)−k+1 to M+1 of the MED cost matrix determine the minimum score, MinScore(j−1) in column j−1 of the cost matrix.

If MinScore (j−1)>Sₘₐₓ then using the early stopping optimisation, this sequence can be declared as not being a putative occurrence and processing can stop. All the elements for column j of the cost matrix are then calculated and S=BESTMED( . . . ) in the normal fashion given this MED cost matrix.

Determining the MED between two sequences requires the computation of a cost matrix, Ω, which is an O(N²) algorithm. Using the optimisations described above significantly reduces the number of computations required to generate this cost matrix, but nevertheless the overall algorithm is still of O(N²) complexity.

In this instance an O(N) complexity derivative of the MED algorithm is used to estimate an approximation of the MED. This results in a further reduction in the number of computations required for MED scoring, thus yielding even faster search speeds.

As discussed above discussed it was necessary to use an infinite deletion cost function to obtain good retrieval accuracy. Given this, the standard cost matrix update equation for MED becomes:

$$\begin{matrix}{Ω}_{ i , j} = Min ( \begin{matrix}{Ω}_{i , j - 1} + ∞ \\ {Ω}_{i - 1 , j} + {C}_{i}^{- 1} ( {p}_{i} ) \\ {Ω}_{i - 1 , j - 1} + {C}_{s} ( {p}_{i} , {q}_{j} )\end{matrix} ) & ( 51 ) \\ = Min ( \begin{matrix}{Ω}_{i - 1 , j} + {C}_{i}^{- 1} ( {p}_{i} ) \\ {Ω}_{i - 1 , j - 1} + {C}_{s} ( {p}_{i} , {q}_{j} )\end{matrix} ) & ( 52 )\end{matrix}$$

which is simply a direct comparison between the cost of inserting an element versus substituting an element. This effectively makes the top-right triangle of the MED cost matrix redundant since information from it is no longer required for computation of the cost matrix.

Additionally, because deletions are no longer considered, then element Ω(i,N) in the final column of the cost matrix must be the result of exactly (M−i)∀i≦M insertions where M is the number of elements in the source sequence A and N is the number of elements in the target sequence B. This is because, it is now only possible to move diagonally down and right (substitution or match), or directly right (insertion), since deletions are no longer allowed.

Thus it is not possible to trace a path to Ω(i,N) without performing exactly (i−M) insertions (or moving right (M−i) times).

If it can be assumed that insertions on average are more expensive than substitution, then clearly it would be less costly to select the set of transforms dictated by element Ω(i,N) than those dictated by element Ω(k,N) if i>k. The validity of this assumption can be maintained by using a high insertion penalty when generating lattices.

Then to obtain an approximation of MED(A,B), it would be on average more computationally efficient to compute the values in the final column in the order Ω(M,N), followed by (M−1,N), followed by (M−2,N), etc, since the transformations dictated by (M—i,N) are on average more likely to be less costly than the transformations dictated by (M−k,N)∀i<k.

Thus an algorithm that favours computation of (M−1,N) over (M−k,N) where i<k will on average result in the correct estimate of the minimum cost to transform sequence A to sequence B. The following algorithm is used to perform this type of biased calculation.

Let the source sequence be given by P=(p₁,p₂, . . . ,p_{M}) and the target sequence be given by Q=(q₁,q₂, . . . ,q_{N}). Then assuming N≧M the linearised MED cost vector, Ω′=(Ω′(1),Ω′(2), . . . ) is derived, where Ω′(i) corresponds to the approximate minimum cost of transforming subsequence (A)₁ⁱ to subsequence (B)₁^{i-k} where k is equal to the number of insertions that have occurred prior to Ω′(i). The Linearised MED cost vector thus plays a similar role to the MED cost matrix in the standard MED formulation.

Elements of Ω′ are computed recursively in a similar fashion to the standard MED algorithm, using an update equation based on equation 52 above as follows.

Firstly a linearised MED cost vector of size M is initialised (where M is the length of the source sequence P) and the position pointers i and j are set to 1 (i.e. i=1, j=1). While i≦M the current cost vector is updated using the update equation:

$${Ω}^{′} ( i ) = Min ( \begin{matrix}{Ω}^{′} ( i - 1 ) + {C}_{i}^{- 1} ( {p}_{i} ) \\ {Ω}^{′} ( i - 1 ) + {C}_{s} ( {p}_{i} , {q}_{j} )\end{matrix} ) \qquad ( 53 )$$

If minimum cost was substitution then increment target sequence position pointer, j=j+1, if j≧N then terminate matching as the entire target sequence has been matched, with a cost of Ω′(i) else increment the source sequence position pointer, i=i+1. If the entire source sequence has been processed without reaching the end of the target sequence a match score of ∞ is then declared.

The above algorithm has an O(N) complexity and thus considerably more computationally efficient than the standard O(N²) MED algorithm. This provides significant benefits in the sequence database and hypersequence database search stages.

In addition to this the previously described prefix sequence and early stopping optimisations can be easily incorporated into the algorithm to provide further improvements in speed. The resulting Linearised MED algorithm that incorporates these optimisations is as follows.

Firstly a linearised MED cost vector of size Mₘₐₓ, where Mₘₐₓ is the maximum length of the observed phone sequences. For each sequence in the observed phone sequence collection, where the collection has been sorted lexically, and the orders of prefix similarity have been computed, let k be defined as the previously computed degree of prefix similarity metric between this sequence and the previous sequence. Δ(P,Q) is then determined as follows using the prefix sequence optimisation, it is only necessary to update the trailing elements of the linearised MED cost vector. Thus, the initial position pointers are initialised as:
i=k (54)
j=ω(i) (55)
where ω(i) is the value of j at which the value of Ω′(i) was last computed (or zero on the first iteration). While i≦M the current cost vector is updated using the update equation:

$${Ω}^{′} ( i ) = Min ( \begin{matrix}{Ω}^{′} ( i - 1 ) + {C}_{i}^{- 1} ( {p}_{i} ) \\ {Ω}^{′} ( i - 1 ) + {C}_{s} ( {p}_{i} , {q}_{j} )\end{matrix} ) \qquad ( 56 )$$

If minimum cost was substitution then increment target sequence position pointer, j=j+1, if Ω′(i)>δ else increment the source sequence position pointer, i=i+1. Then using the early stopping optimisation, declare this sequence as having a match score of ∞ and terminate matching for the sequence. If j≧N then terminate matching as the entire target sequence has been matched, with a cost of Ω′(i) else increment the source sequence position pointer, i=i+1. If the entire source sequence has been processed without reaching the end of the target sequence a match score of o is then declared. Once Δ(P,Q) has been determined normal retrieval processing is then performed.

In one experiment performed by the applicant to compare the performance of the Dynamic Match Lattice Spotting technique of the present invention against conventional indexing techniques, a keyword spotting evaluation set was constructed using speech taken from the TIMIT test database. The choice of query words was constrained to words that had 6-phone-length pronunciations to reduce target word length dependent variability.

Approximately 1 hour of TIMIT test speech (excluding SA1 and SA2 utterances) was labelled as evaluation speech. From this speech, 200 6-phone-length unique words were randomly chosen and labelled as query words. These query words appeared a total of 480 times in the evaluation speech.

16-mixture tri-phone HMM acoustic models and a 256-mixture Gaussian Mixture Model background model were then trained on a 140 hour subset of the Wall Street Journal 1 (WSJ1) database for use in the experiment. Additionally 2-gram and 4-gram phone-level language models were trained on the same section of WSJ1 for use during the lattice building stages of DMLS and the conventional lattice-based methods.

All speech was parameterised using Perceptual Linear Prediction coefficient feature extraction and Cepstral Mean Subtraction. In addition to 13 static Cepstral coefficients (including the 0th coefficient), deltas and accelerations were computed to generate 39-dimension observation vectors.

Lattices were then constructed, based on the optimised DMLS lattice building approach described above. The lattices were generated for each utterance by performing a U-token Viterbi decoding pass using the 2-gram phone-level language model. The resulting lattices were expanded using the 4-gram phone-level language model. Output likelihood lattice pruning was then applied using a beam-width of W to reduce the complexity of the lattices. This essentially removed all paths from the lattice that had a total likelihood outside a beamwidth of W of the top-scoring path. A second V-token traversal was performed to generate the top 10 scoring observed phone sequences of length 11 at each node (allowing detection of sequences of up to 11−MAX(Cᵢ)×Sₘₐₓ phones).

Lattice building was only performed once per utterance. The resulting phone sequence collections were then stored to disk and used during subsequent query-time search experiments.

The sequence matching threshold, Sₘₐₓ, was fixed at 2 for all experiments unless noted otherwise. MED calculations used a constant deletion cost of C_{d}⁻¹=∞, as preliminary experiments obtained poor results when non-infinite values of C_{d}⁻¹ were used. The insertion cost was also fixed at Cᵢ⁻¹=1.

In contrast, Cₛ was allowed to vary based on phone substitution rules. The basic rules used to obtain these costs are shown in table III(a) and were determined by examining phone recogniser confusion matrices. However some exceptions to these rules were made based on empirical observations from small scale experiments. The final set of substitution costs used in the reported experiments is given in table III(b). Substitutions were completely symmetric. Hence the substitution of a phone, m, in a given phone group with another phone, n, in the same group yielded the same cost as the substitution of n with phone m.

TABLE III
PHONE SUBSTITUTION COSTS FOR DMLS

| (a) Rules used to derive phone substitution costs | | (b) Actual phone substitution costs | | | |
|---|---|---|---|---|---|
| Rule | Cost | Phones | Cost | Phones | Cost |
| same-letter consonant phone substitution | 0 | aa ae ah ao aw ax ay | 1 | d dh | 0 |
| eg. [symbol] | | eh en er ih iy | | n nx | 0 |
| vowel substitutions | 1 | ow oy uh uw | | t th | 0 |
| closure and stop substitutions | 1 | b d dh g k p t th jh | 1 | uw w | 1 |
| all other substitutions | ∞ | z zh s sh | 1 | w wh | 0 |

Each system was then evaluated by performing single-word keyword spotting for each query word across all utterances in the evaluation set. The total miss rate for all query words and the False Alarm per keyword occurrence rate (FA/kw) were then calculated using reference transcriptions of the evaluation data. Additionally the total CPU processing seconds per queried keyword per hour (CPU/kw-hr) was measured for each experiment using a 3 GHz lntel™ Pentium 4 processor. For DMLS, CPU/kw-hr only included the CPU time used during the DMLS search stage. That is, the time required for lattice building was not included. All experiments used a commercial-grade decoder to ensure that the best possible CPU/kw-hr results were reported for the HMM-based system. This is because HMM-based keyword spotting time performance is bound by decoder performance.

For clarity of discussion the notation DMLS [U, V, W, Sₘₐₓ] is used to specify DMLS configurations, where U is the number of tokens for lattice generation, V is the number of tokens for lattice traversal, W is the pruning beamwidth, and Sₘₐₓ is the sequence match score threshold. The notation HMM[α] is used when referring to baseline HMM systems where α was the duration-normalised output likelihood threshold used. Additionally the baseline conventional lattice-based method is referred to as CLS.

Performances for the DMLS, HMM-based and lattice-based systems measured for the TIMIT evaluation set are shown in Table IV. For this set of experiments, the DMLS[3,10,200,2] configuration was arbitrarily chosen as the baseline DMLS configuration.

TABLE IV
Baseline results Evaluated on TIMIT

| | Miss | FA/ | CPU/ |
|---|---|---|---|
| Method | Rate | kw | kw-hr |
| HMM[∞] | 1.6 | 44.2 | 94.8 |
| HMM[−7580] | 10.4 | 36.6 | 94.8 |
| HMM[−7000] | 39.8 | 16.8 | 94.8 |
| CLS[3,10,200,0] | 32.9 | 0.4 | — |
| DMLS[3,10,200,2] | 10.2 | 18.5 | 18.0 |

The timing results demonstrate that as expected DMLS was significantly faster than the HMM method, running approximately 5 times faster. This amounts to a baseline DMLS system being capable of searching 1 hour of speech in 18 seconds. DMLS also had more favourable FA/kw performance at 10.2% miss rate, it had a FA/kw rate of 18.5, significantly lower than the 36.6 FA/kw rate achieved by the HMM[−7580] system. However, the HMM system was still capable of achieving a much lower miss rate of 1.6% using the HMM[∞] configuration, though at the expense of considerably more false alarms. The miss rate achieved by the conventional lattice-based system was very poor compared to that of DMLS. This confirms that the phone error robustness inherent in DMLS yields considerable detection performance benefits. However, the false alarm rate for CLS was dramatically better than all other systems, though with a high miss rate.

Thus a considerable improvement in miss rate for DMLS over the baseline lattice-based system is achievable. The improvements in performance could be attributed to the four main cost rules used in the dynamic match process insertions, i.e. same letter substitutions (e.g. |d|⇄|dh|, |n|⇄|nx|), vowel substitutions and closure/stop substitutions (e.g. |b|⇄|d|, |k|⇄|p|). Accordingly further experiments were conducted to quantify the benefits of individual cost rules.

A number of specialized DMLS systems were built to evaluate the effects of individual cost rules in isolation. The systems were implemented using customized MED cost functions as show in table V below:

TABLE V
Cost rules for Isolated Rule DMLS systems

| System | C_{d} | Cₜ | C(a, b) |
|---|---|---|---|
| Same letter | ∞ | ∞ | a and b same letter base, 1 |
| subst | | | otherwise, ∞ |
| Vowel | ∞ | ∞ | a and b are vowels, 1 |
| subst | | | otherwise, ∞ |
| Closure/stop | ∞ | ∞ | a and b are closure/stop, 1 |
| subst | | | otherwise, ∞ |
| Insertions | ∞ | 1 | ∞ |

The evaluation set, recogniser parameters, experimental procedure and DMLS algorithm are the as that used in the above discussed evaluation experiment for the optimised DMLS system.

Table VI shows the results of the specialised DMLS systems, baseline lattice-based CLS system and the previously evaluated DMLS [3,10,200,2] system with all MED rules.

TABLE VI
TIMIT Performance When Isolating Various DP Rules

| | Miss | FA/ |
|---|---|---|
| Method | Rate | kw |
| CLS[3,10,200,0] | 32.9 | 0.4 |
| DMLS[3,10,200,2] insertions | 28.5 | 1.2 |
| DMLS[3,10,200,2] same letter subst | 31.0 | 0.5 |
| DMLS[3,10,200,2] vowel subst | 15.6 | 7.8 |
| DMLS[3,10,200,2] closure/stop subst | 23.5 | 3.0 |
| DMLS[3,10,200,2] all rules | 10.2 | 18.5 |

The experiments demonstrate that the magnitude of contributions of the various rules to overall detection performance varies drastically. Interestingly no single rule brought performance down to the all rules DMLS system. This indicates that the rules are complementary in nature and yield a combined overall improvement in miss rate performance.

Using the same letter substitution rules only yielded a small gain in performance over the null-rule CLS system: 1.9% absolute in miss rate with only a 0.1 drop in FA/kw rate. The result suggests that the phone-lattice is already robust to same letter substitutions, and as such, inclusion of this does not obtain significant gains in performance. Empirical study of the phone-lattices revealed this to be the case in many situations. For example, typically if the phone |s| appeared in the lattice, then it was almost guaranteed that the phone |sh| also appeared at a similar time location in the lattice.

The insertions-only system yielded a slightly larger gain of 4.4% absolute in miss rate with only a 0.8 drop in FA/kw rate. The result indicates that the lattices contain extraneous insertions across many of the multiple hypotheses paths, preventing detection of the target phone sequence when insertions are not accounted for. This observation is to be expected since phone recognisers typically do have significant insertion error rates, even when considering multiple levels of transcription hypotheses.

A significant absolute miss rate gain of 17.3% was observed for the vowel substitution system. However, this gain was at the expense of a 7.4 absolute increase in FA/kw rate. This is a pleasing gain and is supported by the fact that vowel substitution is a frequent occurrence in the realisation of speech. As such, incorporating support for vowel substitutions in DMLS not only corrects errors in the phone recogniser but also accommodates this habit of substitution in human speech.

Finally, significant gains were also observed for the closure/stop substitution system. An absolute gain of 9.4% in miss rate combined with an unfortunate 2.6 absolute increase in FA/kw rate was obtained for this system. Typically closures and stops are shorter acoustic units and therefore more likely to yield classification errors. As such, even though the phone lattice encodes multiple hypotheses, it appears that it is still necessary to incorporate robustness against closure/stop confusion for lattice-based keyword spotting.

The above discussed experiments demonstrate the benefits of the various classes of MED rules used in the evaluated DMLS systems. It should be noted that even the simplest of these rules provided tangible gains in DMLS system performance over that of the baseline system. The experimental results showed that insertion and same-letter consonant substitution rules only provided a small performance benefit over a conventional lattice-based system, whereas vowel and closure/stop substitution rules yielded considerable gains in miss rate. Gains in miss rate were typically offset by increases in FA/kw rate, although the majority of these gains were fairly small, and would most likely be justifiable in light of the resulting improvements in miss rate.

In addition to the above experiments were also conducted to quantify the effect of individual DMLS algorithm parameters on detection performance. The evaluation set, recogniser parameters, experimental procedure are the same as that used in evaluation of the fixed DMLS [3, 10, 200, 2] configuration discussed above.

The number of tokens used for lattice generation, U, has a direct impact on the maximum size of the resulting phone lattice. For example, if a value of U=3 is used, then a lattice node can have at most 3 predecessor nodes. Whereas, if a value of U=5 is used, then the same node can have up to 5 predecessor nodes, greatly increasing the size and complexity of the lattice when applied across all nodes.

Tuning of U directly affects the number of hypotheses encoded in the lattice, and hence the best achievable miss rate. However, using larger values of U also increases the number of nodes in the lattice, resulting in an increased amount of processing during DMLS searching and therefore increased execution time.

Table VII shows the result of increasing U from 3 to 5. As expected, increasing U resulted in an improvement in miss rate of 4.4% absolute but also in an increase in execution time by a factor of 2.3. A corresponding 19.9 increase FA/kw rate was also observed. The obvious benefit of tuning the number of lattice generation tokens is that appreciable gains in miss rate can be obtained. Although this has a negative effect on FA/kw rate, a subsequent keyword verification stage may be able to accommodate the increase.

TABLE VII
Effect of Adjusting Number of Lattice Generation Tokens

| Method | Miss Rate | FA/kw | CPU/kw-hr |
|---|---|---|---|
| DMLS[3,10,200,2] | 10.2 | 18.5 | 18.0 |
| DMLS[5,10,200,2] | 5.8 | 38.4 | 42.6 |

As discussed above lattice pruning is to remove less likely paths from the generated phone lattice, thus making the lattice more compact. This is typically necessary when language model expansion is applied. For example, applying 4-gram language model expansion to a lattice generated using a 2-gram language model results in a significant increase in the number of nodes in the lattice, many of which may now have much poorer likelihoods due to additional 4-gram language model scores.

The direct benefit of applying lattice pruning is an immediate reduction in the size of the lattice that needs to be searched. Resulting improvements in execution time, though at the expense of losing potentially correct paths that unfortunately did not score well linguistically.

Table VIII shows the effect of pruning beamwidth W for four different values 150, 200, 250 and ∞. As predicted, decreasing pruning beamwidth yielded significant gains in execution speed at the expense of reductions in miss rate. Corresponding drops in FA/kw rate were also observed.

TABLE VIII
Effect of Adjusting the Pruning Beamwidth

| Method | Miss Rate | FA/kw | CPU/kw-hr |
|---|---|---|---|
| DMLS[3,10,150,2] | 12.5 | 12.2 | 10.8 |
| DMLS[3,10,200,2] | 10.2 | 18.5 | 13.0 |
| DMLS[3,10,250,2] | 9.2 | 24.7 | 28.2 |
| DMLS[3,10,∞,2] | 7.3 | 60.6 | 175.8 |

Thus adjusting the pruning beamwidth appears to be particularly well suited for tuning execution time. The changes in CPU/kw-hr figures were dramatic, and in comparison, the miss rate figures varied in a much smaller range.

The number of lattice traversal tokens, V, corresponds to the number of tokens used during the secondary Viterbi traversal. Tuning this parameter affects how many tokens are propagated out from a node, and hence, the number of paths entering a node that survive subsequent propagation.

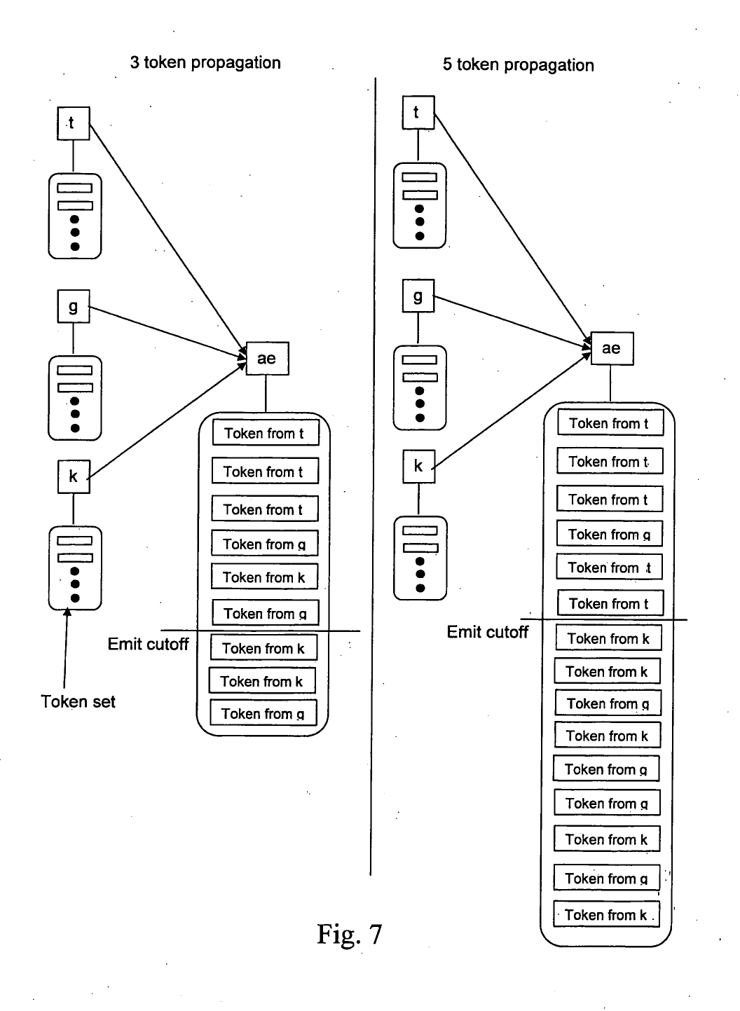

The impact of this on DMLS is actually more subtle, and is demonstrated by FIG. 7. In this instance, the scores of tokens propagated from the t node are much higher than the scores from the other nodes. As such, in the 5-token propagation case, the majority of the high-scoring tokens in the target node are from the t node. Hence the tokens above the emission cutoff (i.e. the tokens from which observed phone sequences are generated) are mainly t nodes. However, using the same emission cutoff and 3-token propagation results in a set of top-scoring tokens from a variety of source nodes it is not immediately obvious whether it is better to use a high or low number of lattice traversal tokens for optimal DMLS performance.

Table IX shows the results of experiments using three different numbers of traversal tokens 5, 10 and 20. It appears that all three measured performance metrics were fairly insensitive to changes in the number of traversal tokens. There was a slight decrease in miss rate when using a higher value of V, though this may not be considered a dramatic enough change to justify the additional processing burden required at the lattice building stage.

TABLE IX
Effect of Adjusting Number of Traversal Tokens

| Method | Miss Rate | FA/kw | CPU/kw-hr |
|---|---|---|---|
| DMLS[3,5,200,2] | 10.4 | 17.4 | 16.8 |
| DMLS[3,10,2002] | 10.2 | 18.5 | 18.0 |
| DMLS[3,20,200,2] | 9.8 | 18.8 | 17.4 |

Tuning of the MED cost threshold, Sₘₐₓ, is the most direct means of tuning miss and FA/kw performance. However, if discrete MED costs are used, then Sₘₐₓ itself will be a discrete variable, and as such, thresholding will not be on a continuous scale. The Sₘₐₓ parameter controls the maximum allowable discrepancy between an observed phone sequence and the target phone sequence. Experiments were carried out to study the effects of changes in Sₘₐₓ on performance. The results of these experiments are shown in table X. Since thresholding was applied on the result set of DMLS, there were no changes in execution time.

The experiments demonstrated that adjusting Sₘₐₓ gave dramatic changes in FA/kw. In contrast, the changes in miss rate were considerably more conservative except for the Sₘₐₓ=0 case. Tuning of the MED cost threshold therefore appears to be most applicable to adjusting the FA/kw operating point. This is intuitive since adjusting Sₘₐₓ adjusts how much error an observed phone sequence is allowed to have, and as such has a direct correlation with false alarm rate.

TABLE X
Effect of Adjusting MED cost threshold Sₘₐₓ

| Method | Miss Rate | FA/kw | CPU/kw-hr |
|---|---|---|---|
| DMLS[3,10,200,0] | 31.0 | 0.5 | 18.0 |
| DMLS[3,10,200,1] | 13.3 | 4.3 | 88.0 |
| DMLS[3,10,200,2] | 10.2 | 18.5 | 18.0 |
| DMLS[3,10,200,3] | 8.7 | 52.0 | 18.0 |

Given the above experiments were conducted on systems using a combination of the tuned parameters discussed above. As such, two tuned systems were constructed and evaluated on the TIMIT data set. Parameters for these systems were selected as follows:
1. The number of lattice generation tokens U was set to a value of 5;
2. As the DMLS system performance appeared insensitive to changes in the number of lattice traversal tokens, the value of V was maintained at the value used for the previously discussed experiments i.e. V=10;
3. The speed increases observed using a reduced lattice pruning beamwidth were quite dramatic, and in comparison only resulted in a small decrease in miss rate. Considering the anticipated gains in miss rate from the increase in the number of lattice generation tokens, a reduced value of W=150 was used.
4. Two values of Sₘₐₓ were evaluated to obtain performance at different false alarm points. The values evaluated were Sₘₐₓ=1 and Sₘₐₓ=2. Although it was anticipated that a reduction in miss rate would be observed for the lower Sₘₐₓ=1 system, it was hoped that this would be compensated for by the increase in the number of lattice generation tokens, and further justified by the significantly lower false alarm rate.

The results of the tuned systems on the TIMIT evaluation set are shown in table XI. The first system achieved a significant reduction in FA/kw rate over the initial DMLS [3,10,200,2] system at the expense of only a small 1.3% absolute increase in miss rate. The second system obtained a good decrease in miss rate of 2.9% with only a small 3.8 FA/kw rate increase. Both these systems maintained almost the same execution speed as the initial DMLS system.

TABLE XI
Tuned DMLS Configurations Evaluated on TIMIT

| Method | Miss Rate | FA/kw | CPU/kw-hr |
|---|---|---|---|
| Untuned DMLS[3,10,200,2] | 10.2 | 185 | 18.0 |
| Tuned DMLS[5,10,150,1] | 11.5 | 5.6 | 18.6 |
| Tuned DMLS[5,10,150,2] | 7.3 | 22.3 | 18.6 |

The above discussed experimental evaluation of the DMLS system was conducted in respect of a clean microphone speech domain. The conversational telephone speech domain is a more difficult domain but is more representative of a real-world practical application of DMLS. Accordingly experiments were performed using the Switchboard 1 telephone speech corpus. To maintain consistency, the same baseline systems, DMLS algorithms and evaluation procedure as discussed above.

The evaluation set in this instance was constructed in a similar fashion to the previously constructed TIMIT evaluation set. Approximately 2 hours of speech was taken from the Switchboard corpus and labelled as evaluation speech. From this speech, 360 6-phone-length unique words were randomly chosen and marked as query words. In total, these query words appeared a total of 808 times in the evaluation set.

Acoustic and language models were trained up on a 165 hour subset of the Switchboard-1 database using the same approach as used for the previous TIMIT experiments.

The results for the HMM-based, conventional lattice-based, and DMLS experiments on conversational speech SWB1 data are shown in table XII. DMLS performance was measured using the baseline DMLS[3,10,200,2] system as well as a number of tuned configurations. Tuned systems were constructed using a combination of lattice generation tokens, pruning beamwidth and Sₘₐₓ tuning.

TABLE XII
Keyword Spotting Results on SWB1

| Method | Miss Rate | FA/kw | CPU/kw-hr |
|---|---|---|---|
| HMM[−7500] | 8.0 | 366.9 | 106.2 |
| HMM[−7300] | 14.1 | 319.6 | 106.2 |
| CLS[3, 10, 200, 0] | 38.4 | 3.2 | — |
| DMLS[3, 10, 200, 2] | 17.5 | 59.0 | 30.6 |
| DMLS[5, 10, 150, 2] | 11.0 | 83.6 | 43.2 |
| DMLS[5, 10, 150, 1] | 14.2 | 23.0 | 43.2 |
| DMLS[5, 10, 100, 2] | 13.9 | 36.1 | 10.8 |

It is noted that a dramatic increase in FA/kw rates for all systems compared to those observed for the TIMIT evaluations. This is an expected result, since the conversational telephone speech domain is a more difficult domain for recognition. For DMLS, this increase in false alarm rate is a result of the increased complexity of the lattices. It was found that the lattices generated for the Switchboard data were significantly larger than those generated for the TIMIT data when using the same pruning beamwidth. This meant that there were more paths with high likelihoods, indicating a greater degree of confusability within the lattices. As a result, more false alarms were generated.

Losses in miss rate in the vicinity of 5% absolute were also observed for all systems compared to the TIMIT evaluations. Although this is unfortunate, these losses are still minor in light of the increased difficulty of the data.

Overall though, DMLS still achieved more favourable performance than the baseline HMM-based and lattice-based systems. The DMLS systems not only yielded considerably lower miss rates than CLS but also significantly lower FA/kw and CPU/kw-hr rates than the HMM-based systems.

In terms of detection performance, the two best DMLS systems were the DMLS[5,10,150,1] and the DMLS[5,10,100,2] configurations. Both had lower false alarm rates than the other DMLS systems and still maintained fairly low miss rates. However, the execution speed of the DMLS[5,10,100,2] configuration was 4 times faster than the DMLS[5,10,150,1] system. In fact, this system was capable of searching 1 hour of speech in 10 seconds and thus would be more appropriate for applications requiring very fast search speeds.

Overall, the experiments demonstrate that DMLS is capable of delivering good keyword spotting performance on the more difficult conversational telephone speech domain. Although there was some degradation in performance compared to the clean speech microphone domain, the losses were in line with what would be expected. Also, DMLS offered much faster performance than the HMM-based system and considerably lower miss rates than the conventional lattice-based system.

Experiments were performed to evaluate the execution time benefits of the prefix sequence and early stopping optimisations. Five systems were evaluated as follows:
1) NOPT: DMLS system without prefix sequence and early stopping optimisations;
2) ESOPT: DMLS system with early stopping optimisation;
3) PSOPT: DMLS system with prefix sequence optimisation;
4) COPT: DMLS system with combined early stopping and prefix sequence optimisations; and
5) CXOPT: The COPT system with miscellaneous coding optimisations applied such as removal of dynamic memory allocation, more efficient passing of data, etc.

Experiments were performed using 10 randomly selected utterances from the Switchboard evaluation set detailed above. Single word keyword spotting was performed for each utterance using a 6-phonelength target word. Each utterance was processed repeatedly for the same word 1400 times and the total execution time was measured for all passes. The total time was then summed across all tested utterances to obtain the total time required to perform 10×1400 passes. The relative speeds were calculated by finding the ratio between the measured speed of the tested system and the measured speed of the baseline NOPT system. The entire evaluation was then repeated a total of 10 times and the average relative speed factor was calculated. Execution time was measured on a single 3 GHz Intel™ Pentium 4 processor.

In addition the final putative occurrence result sets were examined to ensure that exactly the same miss rate and FA/kw rates were obtained across all methods, since both optimisations should not affect these metrics. Table XIII shows the speed of each system relative to the baseline unoptimised NOPT using Sₘₐₓ values of 2 and 4, since the benefits of depend on the value of Sₘₐₓ.

TABLE XIII
Relative Speeds of Optimised DMLS systems

| Sₘₐₓ | System | Relative speed factor |
|---|---|---|
| 2 | NOPT | 1.00 |
| 2 | PSOPT | 0.60 |
| 2 | ESOPT | 0.42 |
| 2 | COPT | 0.25 |
| 2 | CXOPT | 0.16 |
| 4 | NOPT | 1.00 |
| 4 | PSOPT | 0.60 |
| 4 | ESOPT | 0.64 |
| 4 | COPT | 0.32 |
| 4 | CXOPT | 0.21 |

The results clearly demonstrate that both optimisations yielded significant speed benefits. An even more pleasing result was that the two optimisations combined effectively to reduce execution time by a factor of 4 for the Sₘₐₓ=2 tests, and by a factor of 3 for the Sₘₐₓ=4 test. Overall the fully optimised CXOPT system ran about 5 to 6 times faster than the original unoptimised system. Table XIV shows the execution time of the unoptimised DMLS system discussed above as well as the CPU/kw-hr figure for the same system incorporating the early stopping and prefix sequence optimisations. It can be seen that the resultant speed is 1.8 CPU/kw-hr. This is an impressive result and clearly emphasises the suitability of DMLS for very fast large database keyword spotting applications.

TABLE XIV
Fully Optimised System on Switchboard

| | Miss | FA/ | CPU/ |
|---|---|---|---|
| Method | Rate | kw | kw-hr |
| DMLS[5, 10, 100, 2] | 13.9 | 36.1 | 10.8 |
| DMLS[5, 10, 100, 2] with CXOPT | 13.9 | 36.1 | 1.8 |

While the above discussed experiments were performed utilising TIMIT and SW01 test database. It will be appreciated by those skilled in the art that such DMLS systems can be utilised across a variety of applications such as podcast indexing and searching, Radio/television/media indexing and searching, Telephone conversation indexing and searching, Call Centre telephone indexing and searching etc.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein and defined in the following claims.

We claim:

1. A computer implemented method of indexing speech content, the method comprising the steps of:
generating a phone lattice from said speech content;
processing the phone lattice to generate a set of observed sequences Q=(Θ,i), wherein Θ are the observed sequences for each node i in said phone lattice; and
storing said set of observed sequences Q=(Θ,i) for each node.

2. The method of claim 1 wherein the step of generating of the phone lattice further comprises the steps of:
performing a feature based extraction process to construct a phone recognition network; and
performing an N-best decoding on said phone recognition network to produce the phone lattice.

3. The method of claim 2 wherein the phone recognition network is constructed using phone loop or phone sequence fragment loop techniques.

4. The method of claim 3 wherein the N-best decoding utilises a set of well trained acoustic models and a language model.

5. The method of claim 4 wherein the set of well trained acoustic models are tri-phone Hidden Markov Models (HMM) and the language model is an N-gram language model.

6. The method of claim 1 wherein the step of generating the phone lattice further comprises optimising lattice size and complexity by selecting from the following sub-steps:
(a) tuning the number of tokens U used to generate the phone lattice;
(b) pruning less likely paths outside a pruning beamwidth W; and
(c) tuning the number of lattice traversals V.

7. The method of any one of the preceding claims wherein said set of observed sequences Q=(Θ,i) is generated in accordance with Q(Θ,i)={Q¹,Q², . . . }={θ^{k} ∈Θ|θ_{N}^{k}=i}, where Θ={θ₁ⁱ,θ₂ⁱ, . . . } is the set of all N-length sequences θⁱ=(θ₁ⁱ,θ₂ⁱ, . . . ) that exist in the lattice, and wherein each element θₖⁱ corresponds to a node within the lattice.

8. A method for searching indexed speech content wherein said indexed speech content is stored in the form of a phone lattice, the method comprising the steps of:
obtaining a target sequence P=(p₁, p₂, p₃, . . . p_{N});
comparing the target sequence P with a set of observed sequences Q=(Θ,i) generated for each node i in said phone lattice, wherein the comparison between the target sequence and observed sequences includes scoring each observed sequence against the target sequence using a Minimum Edit Distance (MED) calculation; and
outputting a set of sequences R from said set of observed sequences that match said target sequence.

9. The method of claim 8 wherein said set of observed sequences Q=(Θ,i) is generated in accordance with Q(Θ,i)={Q¹,Q², . . . }={θ^{k} ∈Θ|θ_{N}^{k}=}, wherein Θ={θ₁ⁱ,θ₂ⁱ, . . . } is the set of all N-length sequences θⁱ=(θ₁ⁱ,θ₂ⁱ, . . . ) that exist in the phone lattice, and wherein each element θₖⁱ corresponds to a node within the phone lattice.

10. The method of claim 9 the step of scoring each observed sequence against the target sequence further comprises the step of generating a MED cost matrix.

11. The method of claim 10 wherein the MED cost matrix is generated in accordance with a Levenstein algorithm.

12. The method of claim 10 wherein the MED calculation comprises calculating the minimum cost S of transforming each observed sequence within the set of observed sequences into the target sequence in accordance with a set of insertion Cᵢ, deletion C_{d} and substitution Cₛ costs, where S is defined by S=BESTMED(P,Q,C₁,C_{d},Cₛ) and wherein BESTMED( . . . ) returns the last column MED cost matrix that is less than a maximum score threshold Sₘₐₓ.

13. The method claim 12 wherein Cᵢ and C_{d} are fixed and Cₛ is varied according to the following substitution rules:
Cₛ=0 for same letter consonant phone substitutions;
Cₛ=1 for vowel substitutions;
Cₛ=1 for closure and stop substitutions; and
Cₛ=∞ for all other substitutions.

14. The method of claim 12 wherein the MED calculations are optimised by only calculating successive columns of the MED cost matrix if the minimum element of the current column is less than Sₘₐₓ.

15. The method of claim 8 wherein comprising the further steps of:
processing the set of observed sequences Q=(Θ,i) produce a set of hypersequences, wherein each hypersequence represents a particular group of observed sequences Q=(Θ,i).

16. The method of claim 15 wherein the hypersequences are produced by mapping the observed sequences to a hypersequence domain in accordance with a predetermined mapping function.

17. The method of claim 16 wherein the mapping of the observed sequences to the hypersequence domain is performed on an element by element basis using a mapping method selected from:
(a) a linguistic knowledge based mapping;
(b) a data driven acoustic mapping; and
(c) a context dependent mapping.

18. The method of claim 16 wherein the step of comparing the target sequence and the observed sequences comprises:
comparing the target sequence with each hypersequence to identify sequence groups most likely to yield a match for the target sequence; and
comparing said target sequence with the set of observed sequences Q=(Θ,i) contained within the identified hypersequence sequence groups.

19. A system for indexing and searching speech content, the system comprising:
a speech recognition engine for generating a phone lattice from said speech content;
a first database for storing said phone lattice generated by said speech recognition engine;
an input device for obtaining a target sequence P=(p_{1, p}₂, p₃, . . . p_{N});
at least one processor coupled to said input device and said first database, which processor is configured to:
process said phone lattice to generate a set of observed sequences Q=(Θ,i), wherein Θ are the observed sequences for each node i in said phone lattice;
store said observed sequences Q=(Θ,i) in a second database;
compare said target sequence P with the set of observed sequences Q=(Θ,i) wherein the comparison between the target sequence and observed sequences includes scoring each observed sequence against the target sequence using a Minimum Edit Distance (MED) calculation; and
output a set of sequences R from said set of observed sequences Q=(Θ,i) that match said target sequence.

20. The system of claim 19 wherein the speech recognition engine is configured to:
construct a phone recognition network utilising a feature based extraction process;
perform an N-best decoding operation on said phone recognition network to produce the phone lattice; and
store said phone lattice in the first database.

21. The system of claim 20 wherein the feature based extraction process is performed by a speech recognition program.

22. The system of claim 20 wherein the phone recognition network is constructed using phone loop or phone sequence fragment loop techniques.

23. The system of claim 19 where in the N-best decoding utilises a set of well trained acoustic models and an appropriate language model.

24. The system of claim 23 wherein the set of well trained acoustic models are tri-phone Hidden Markov Models (HMM) and the language model is an N-gram language model.

25. The system of claim 19 wherein phone lattice size and complexity is optimised by said at least one processor selecting from the following sub-steps:
(a) tuning the number of tokens U used to generate the phone lattice;
(b) pruning less likely paths outside a pruning beamwidth W; and
(c) tuning the number of lattice traversals V.

26. The system of claim 19 wherein said set of observed sequences Q=(Θ,i) is generated in accordance with Q(Θ,i)={Q¹,Q², . . . }={θ^{k} ∈Θ|θ_{N}^{k}=i}, where Θ={θ₁ⁱ,θ₂ⁱ, . . . } is the set of all N-length sequences θⁱ=(θ₁ⁱ,θ₂ⁱ, . . . ) that exist in the lattice, and wherein each element θₖⁱ corresponds to a node within the lattice.

27. The system of claim 19 wherein scoring each observed sequence against the target sequence further includes generating a MED cost matrix.

28. The system of claim 27 wherein generating the MED cost matrix comprises calculating the minimum cost S of transforming each observed sequence within the set of observed sequences into the target sequence in accordance with a set of insertion Cᵢ, deletion C_{d} and substitution Cₛ costs, where S is defined by S=BESTMED(P,Q,Cᵢ,C_{d},Cₛ) and wherein BESTMED( . . . ) returns the last column MED cost matrix that is less than a maximum score threshold Sₘₐₓ.

29. The system of claim 27 wherein Cᵢ and C_{d} are fixed and Cₛ is varied according to the following substitution rules:
Cₛ=0 for same letter consonant phone substitutions;
Cₛ=1 for vowel substitutions;
Cₛ=1 for closure and stop substitutions; and
Cₛ=∞ for all other substitutions.

30. The system of claim 28 wherein the MED calculations are optimised by only calculating successive columns of the MED cost matrix if the minimum element of the current column is less than Sₘₐₓ.

31. The system of claim 28 wherein the MED cost matrix is generated in accordance with a Levenstein algorithm.

32. Computer readable media having stored thereon instructions for executing, on at least one processor, the steps of the method of indexing speech content of claim 1 or the method of searching indexed speech content of claim 8.
